(19) United States
(12) Patent Application Publication
(10) Pub. No.: US 2014/0150724 A1
(43) Pub. Date: Jun. 5, 2014

(54) BIRDFEEDER

(71) Applicant: Thomas Keith Moone, Chargin Falls, OH (US)

(72) Inventor: Thomas Keith Moone, Chargin Falls, OH (US)

(73) Assignee: Nature's Way LLC, Chargin Falls, OH (US)

(21) Appl. No.: 13/891,956

(22) Filed: May 10, 2013

Related U.S. Application Data
(60) Provisional application No. 61/645,557, filed on May 10, 2012.

(51) Int. Cl. A01K 39/012

(52) U.S. Cl. CPC A01K 39/012
USPC 119/52.1; 119/51.01

(57) ABSTRACT

A birdfeeder has a base (20) comprising a frame (30), a floor (40), and a railing (50). The frame (30) can be inexpensively constructed from wooden boards having standard widths and depths. The floor (40) is selectively removable from the rest of the base (20) and can be economically made from a perforation-provided sheet with unturned edges. The railing (50) is situated below the floor (40) but not below the frame (30) so as to accommodate ledge-seating, limb-hanging, or pole-mounting of the birdfeeder.

### RELATED APPLICATION

This application claims priority under 35 USC §119(e) to U.S. Provisional Patent Application No. 61/645,557 filed on May 10, 2012. The entire disclosure of this provisional patent application is hereby incorporated by reference.

### BACKGROUND

A birdfeeder is often placed in a backyard or other outside venues to attract birds to the area. It is sometimes preferred to suspend a birdfeeder by hanging it from a branch or other limb in a backyard. Another popular arrangement involves elevating the birdfeeder by mounting it on top of a pole. And in some situations, the best option for a birdfeeder is to simply sit on a flat surface, such as a porch ledge.

### SUMMARY

A birdfeeder comprises a base which provides a tray and which can be suspended, pole-mounted, or seated on a flat surface. The base accommodates a floor which is easily removable and which can be inexpensively made from a single sheet (e.g., it has no turned edges). And the base's frame can be economically made from the standard wooden boards.

### DRAWINGS

FIGS. 1A-1H each show a birdfeeder 10.

FIGS. 2A-2H, FIGS. 3A-3H, FIGS. 4A-4H, and FIGS. 5A-5H each show a base 20, a frame 30, a floor 40, and a railing 50 for the birdfeeders 10 shown respectively in FIGS. 1A-1H.

FIGS. 6A-6G, FIGS. 7A-7G, FIGS. 8A-8G each show a hopper 60, a housing 70, and roof 80 for the birdfeeders 10 shown respectively in FIGS. 1A-1H.

FIGS. 9C-9F each show accessories 90 included in the birdfeeders shown respectively in FIGS. 1C-1F.

FIGS. 10A-10H each show platform-seated, limb-suspended, and pole-elevated versions of the birdfeeders 10 shown in FIGS. 1A-1H.

### DESCRIPTION

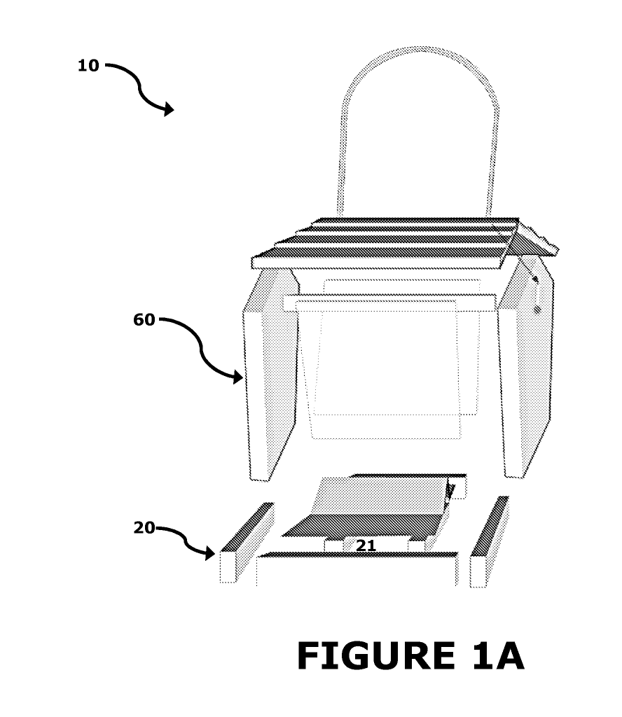

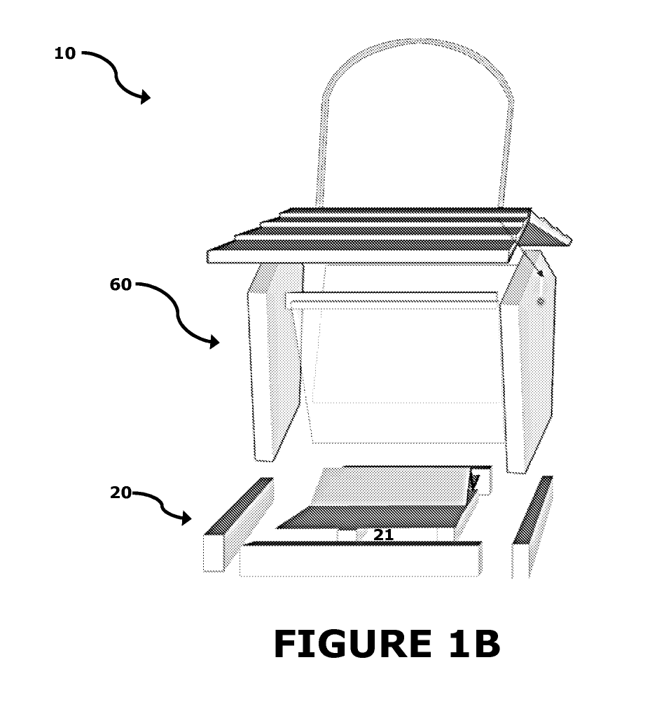

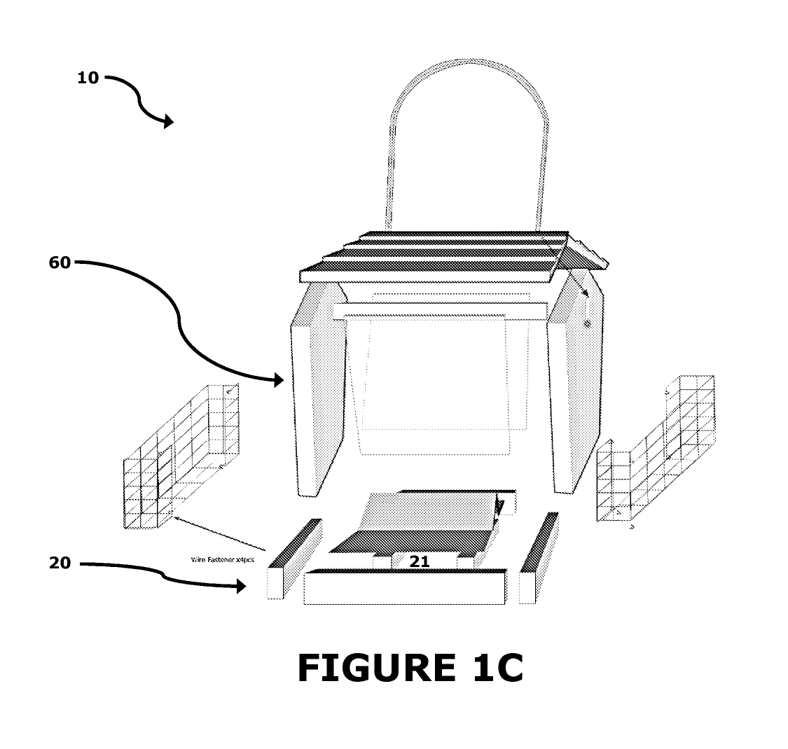

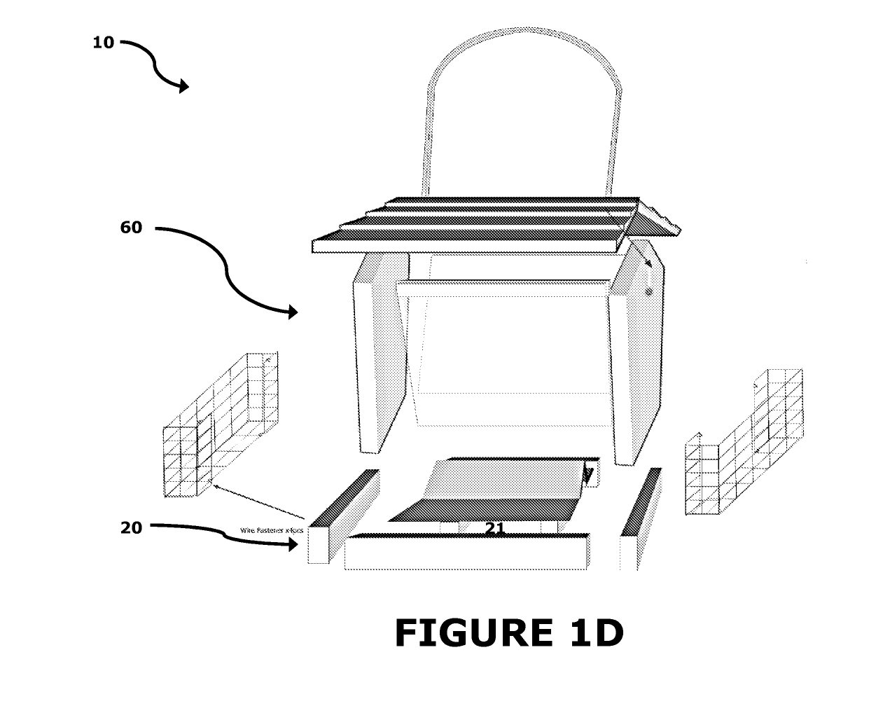

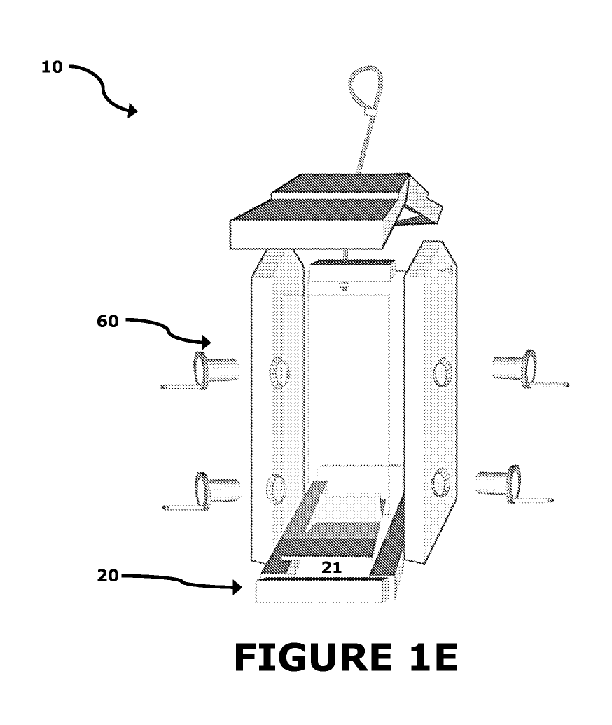

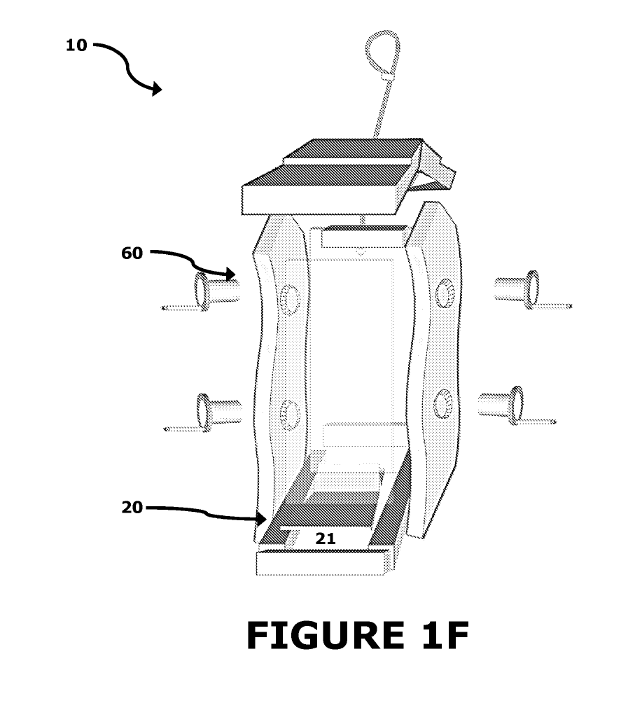

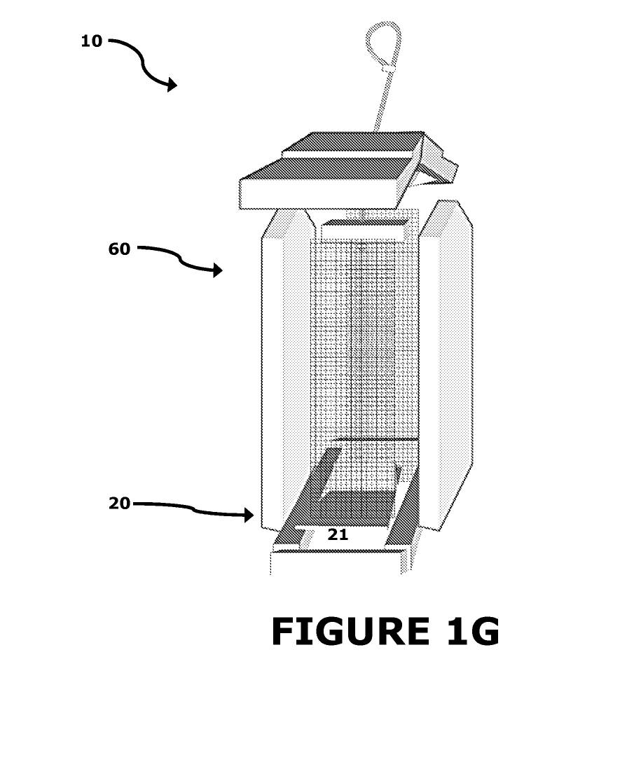

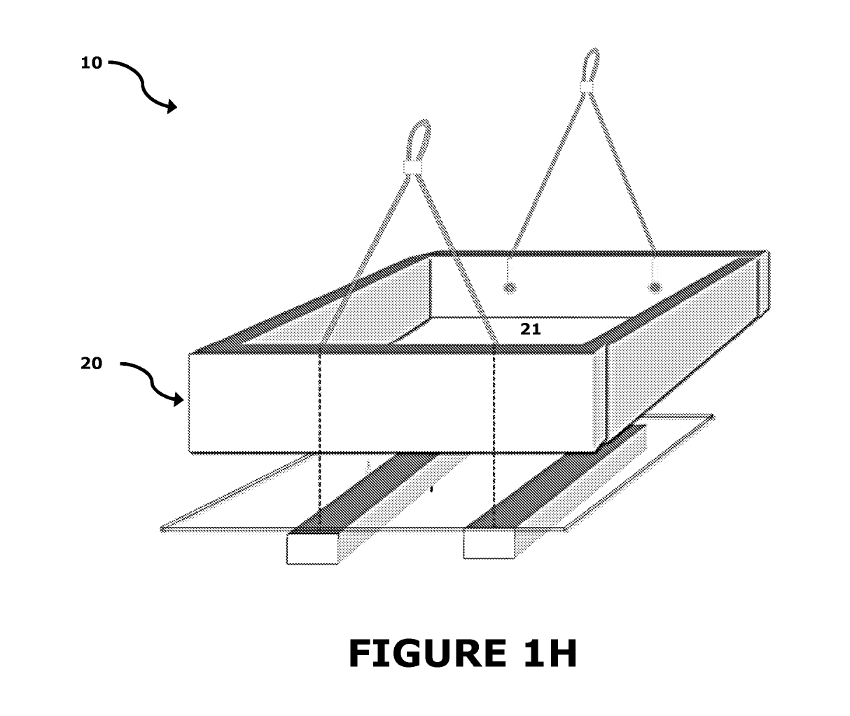

Referring now to the drawings, and initially to FIGS. 1A-1H, some possible embodiments of a birdfeeder 10 are shown, each comprising a base 20 which provides a tray 21 adapted to present birdfeed in an accessible manner.

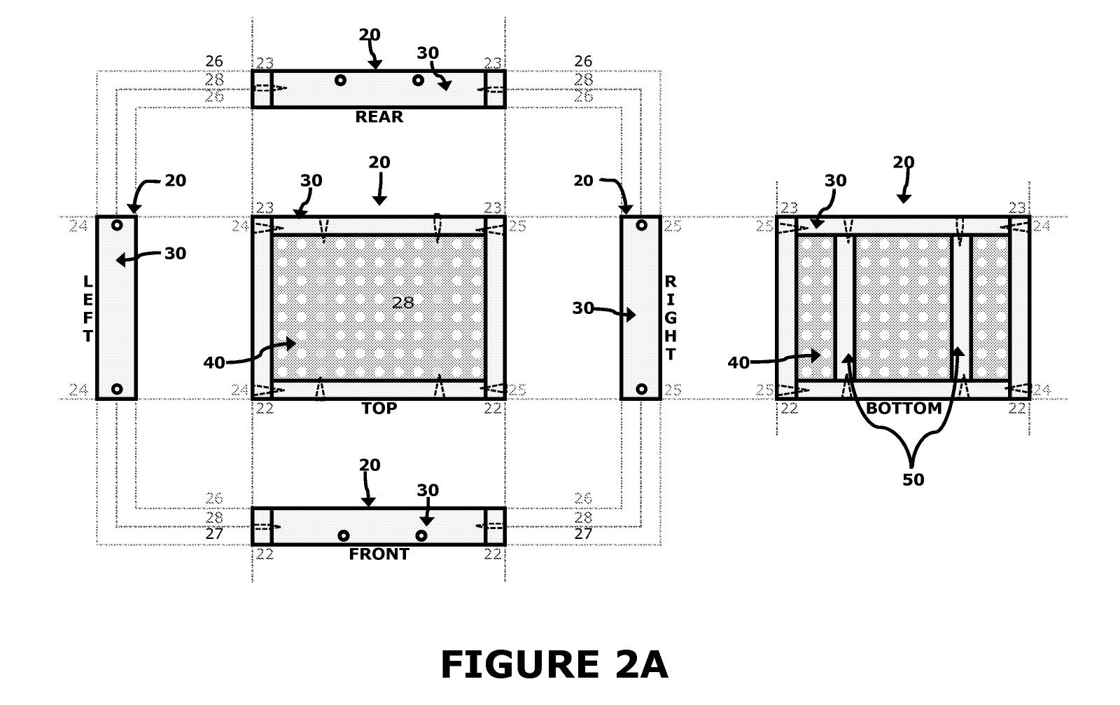

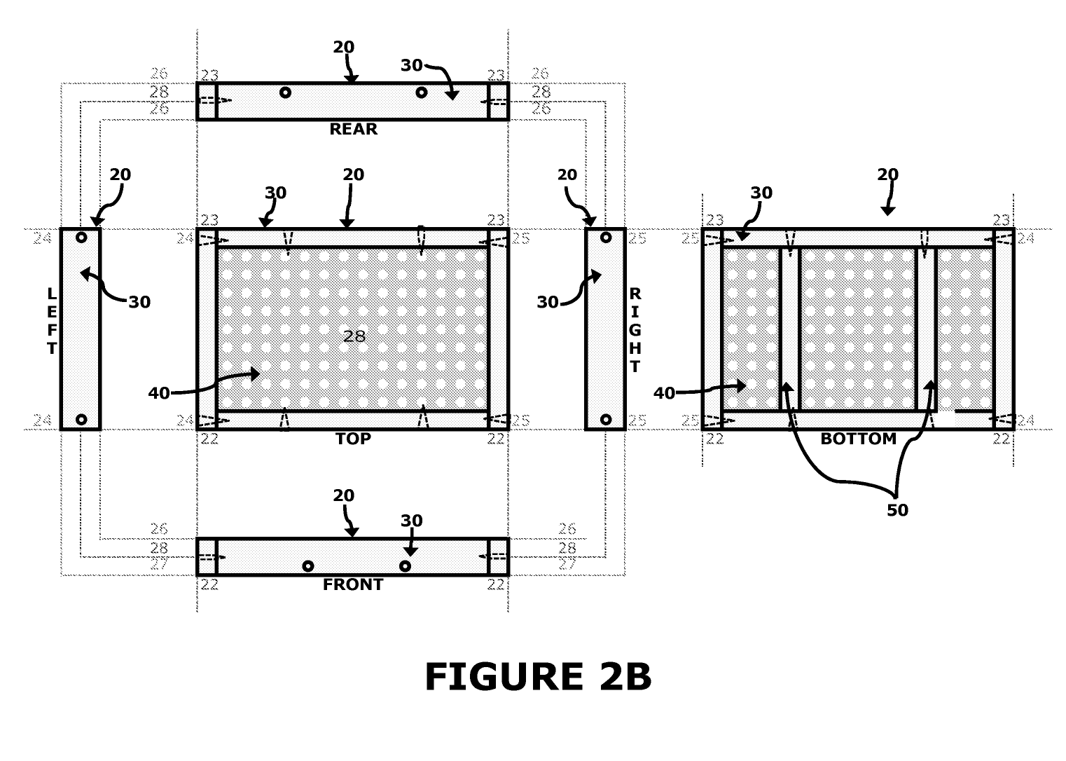

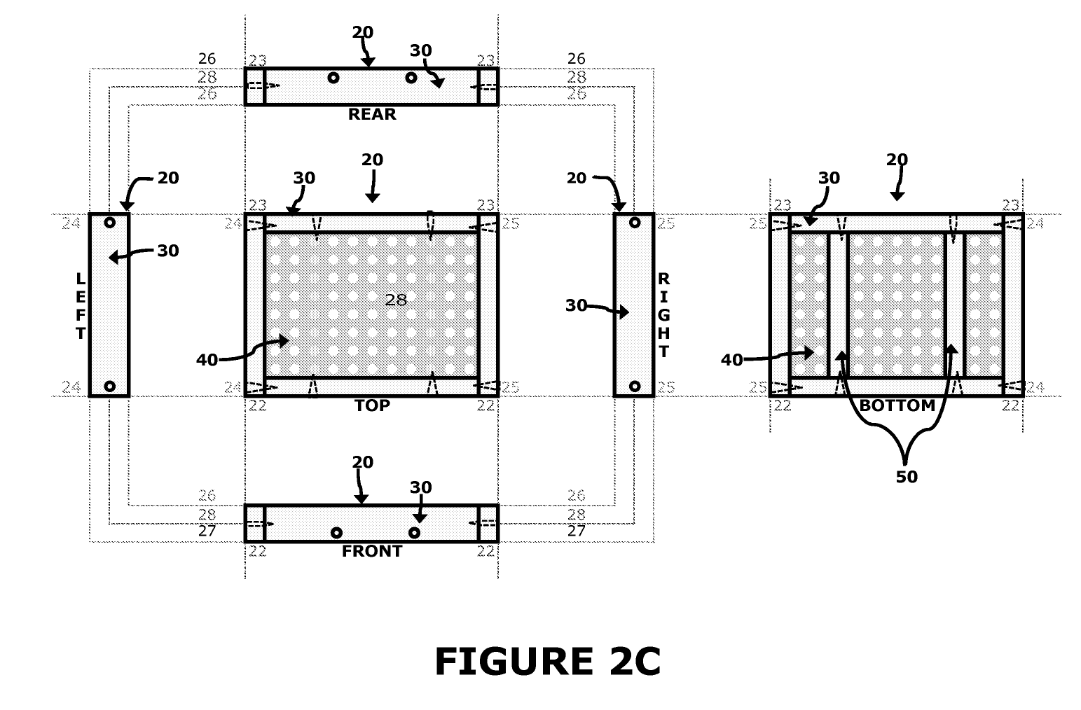

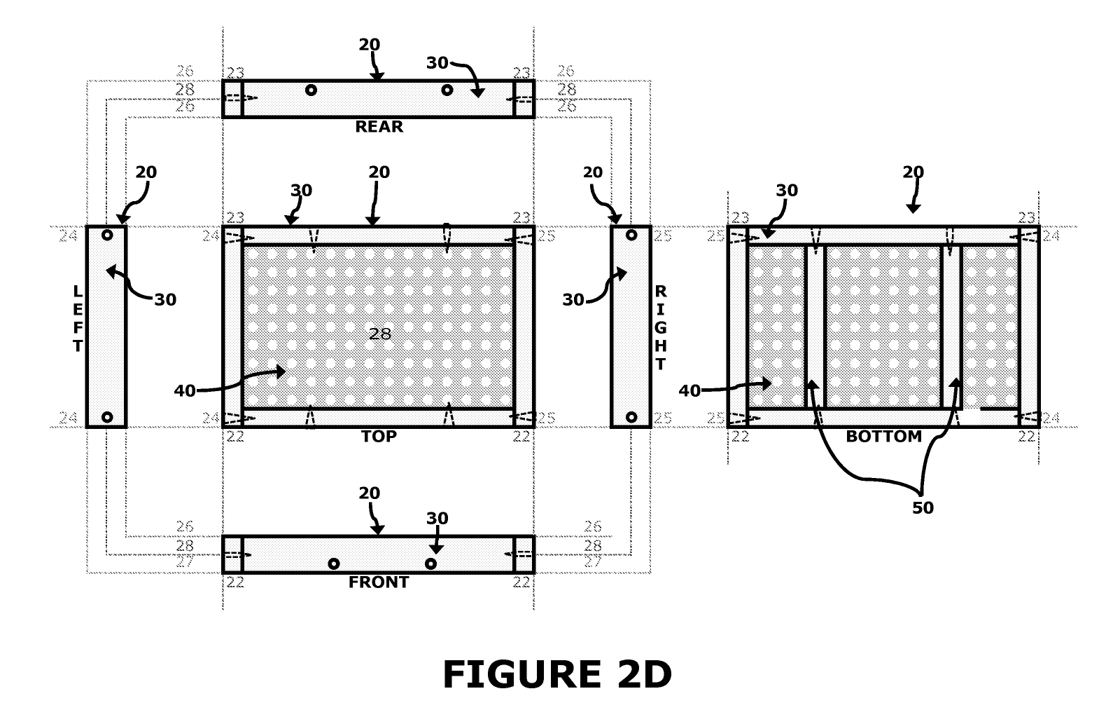

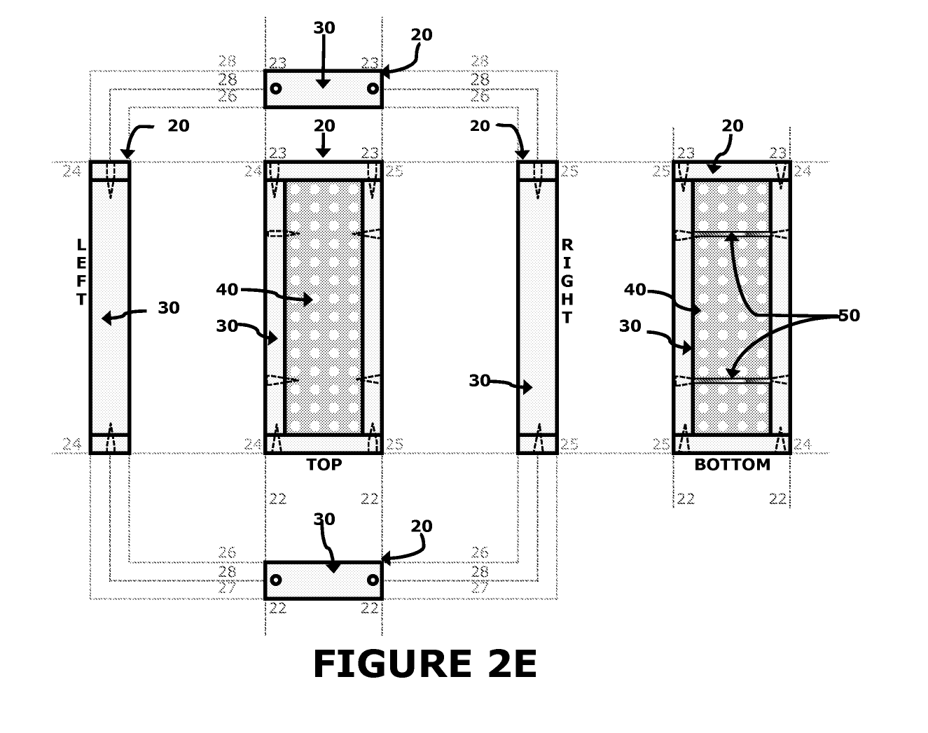

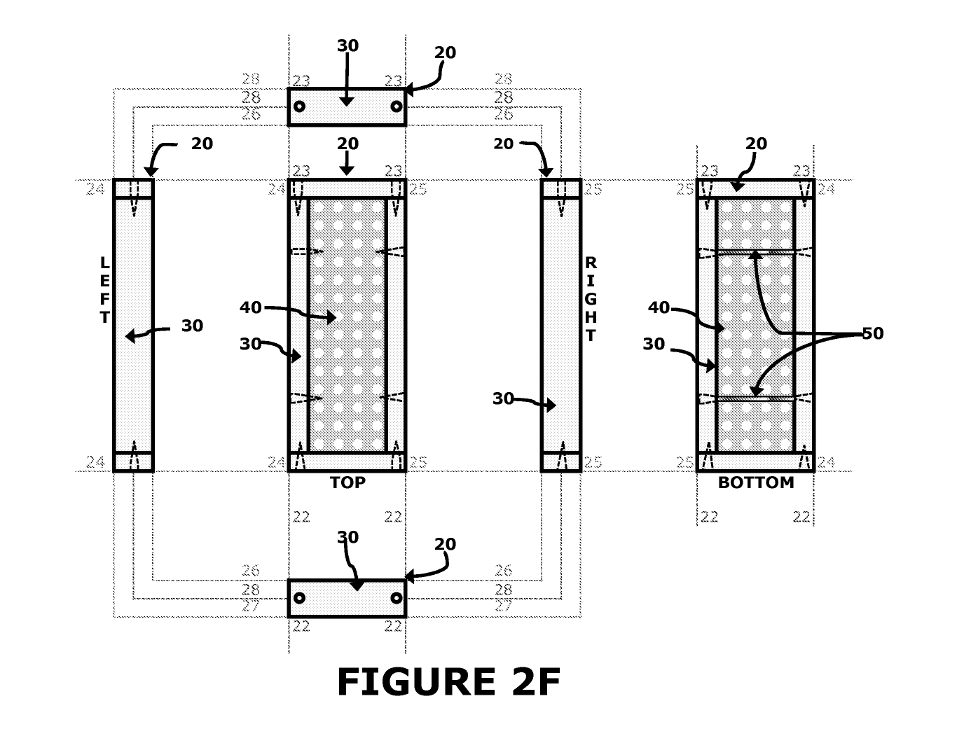

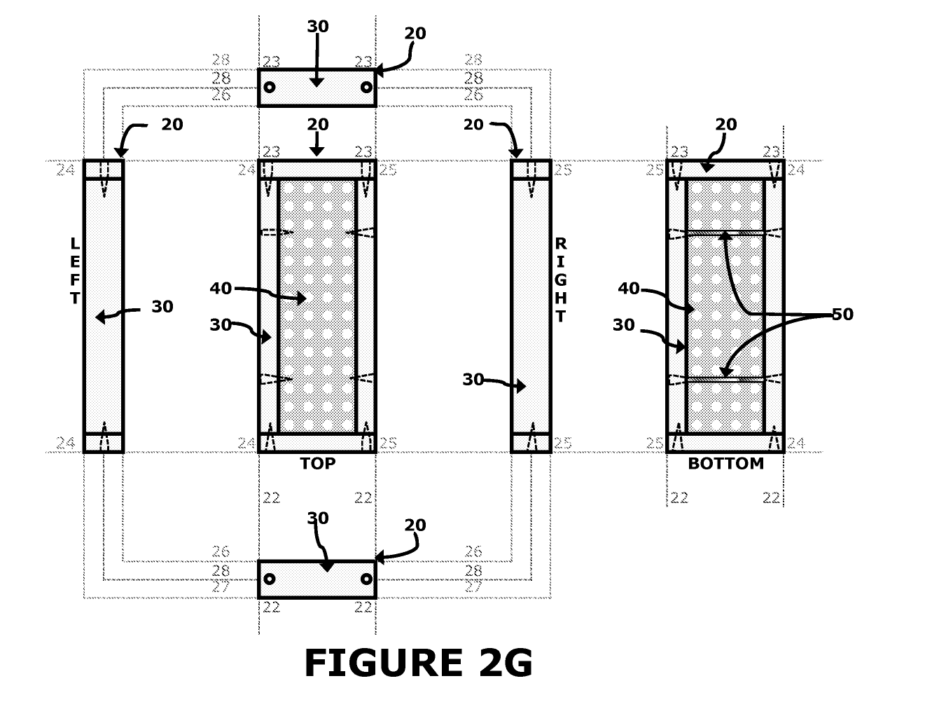

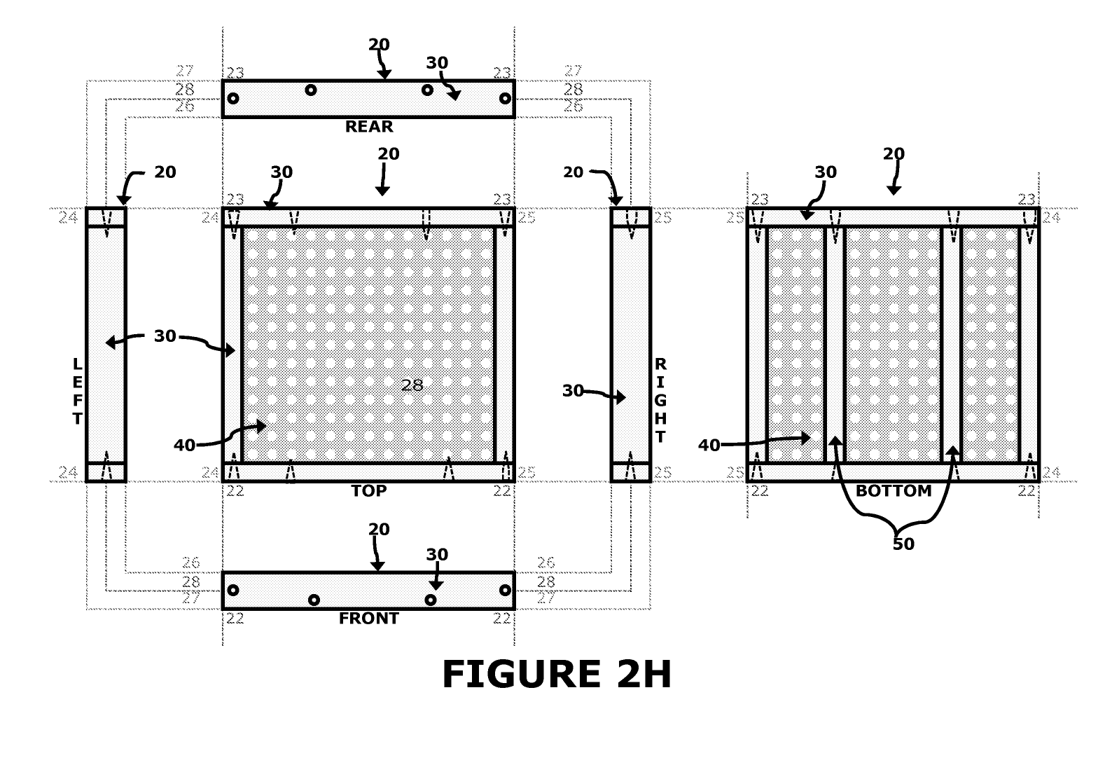

As shown in FIGS. 2A-2H, the base 20 has side boundaries 22-25 (e.g., front boundary 22, rear boundary 23, left boundary 24, right boundary 25), a top boundary 26, and a bottom boundary 27. The tray 21 shares the side boundaries 22-25 and the top boundary 26 with the base 20, but has a bottom boundary 28 positioned above the base's bottom boundary 27.

As also shown in FIGS. 2A-2H, the base 20 comprises a frame 30, a floor 40, and a railing 50. The frame 30 defines the side boundaries 22-24 of the base 20 and the tray 21, the top boundary 25 of the base 20 and the tray 21, and the bottom boundary 27 of the base 20. The floor 40 defines the bottom boundary of the 28 of the tray 21. The railing 50 is situated below the bottom boundary 28 of the tray 21, but not below the bottom boundary 27 of the base 20.

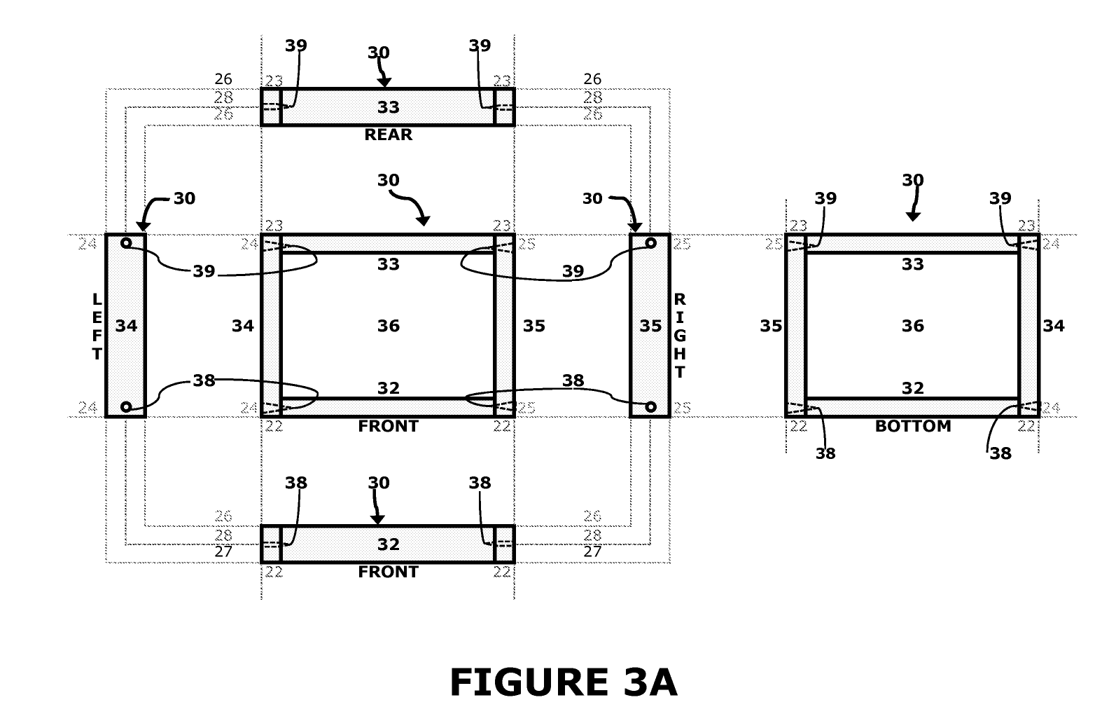

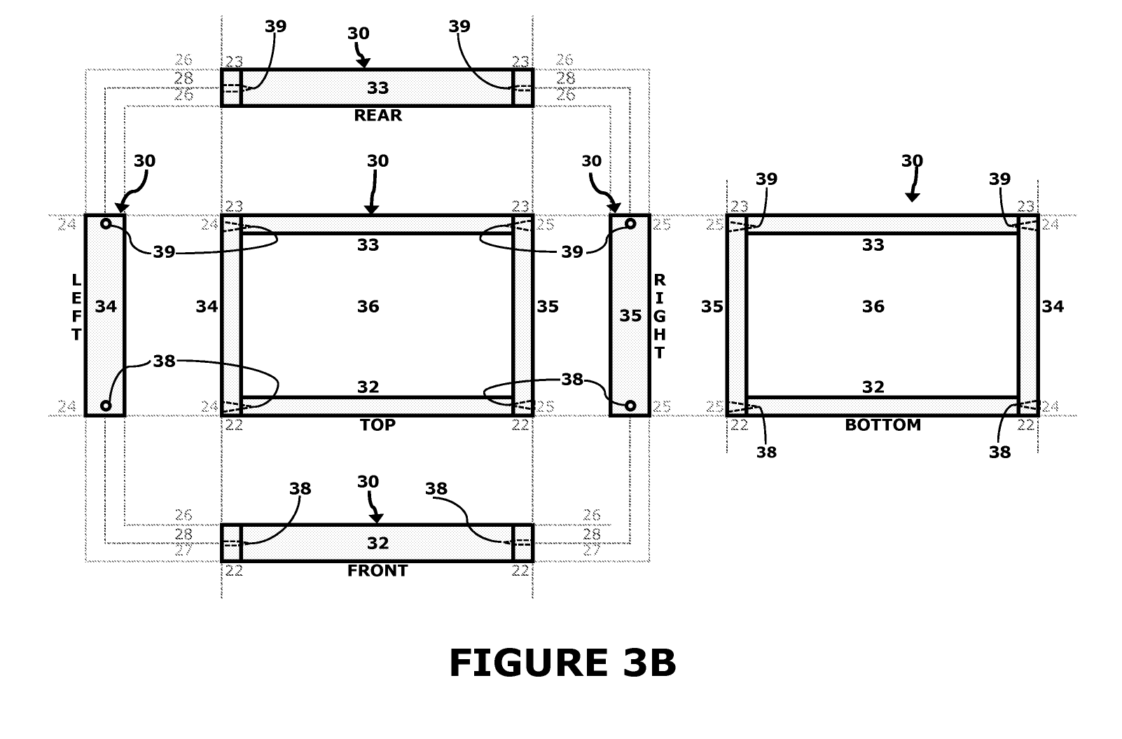

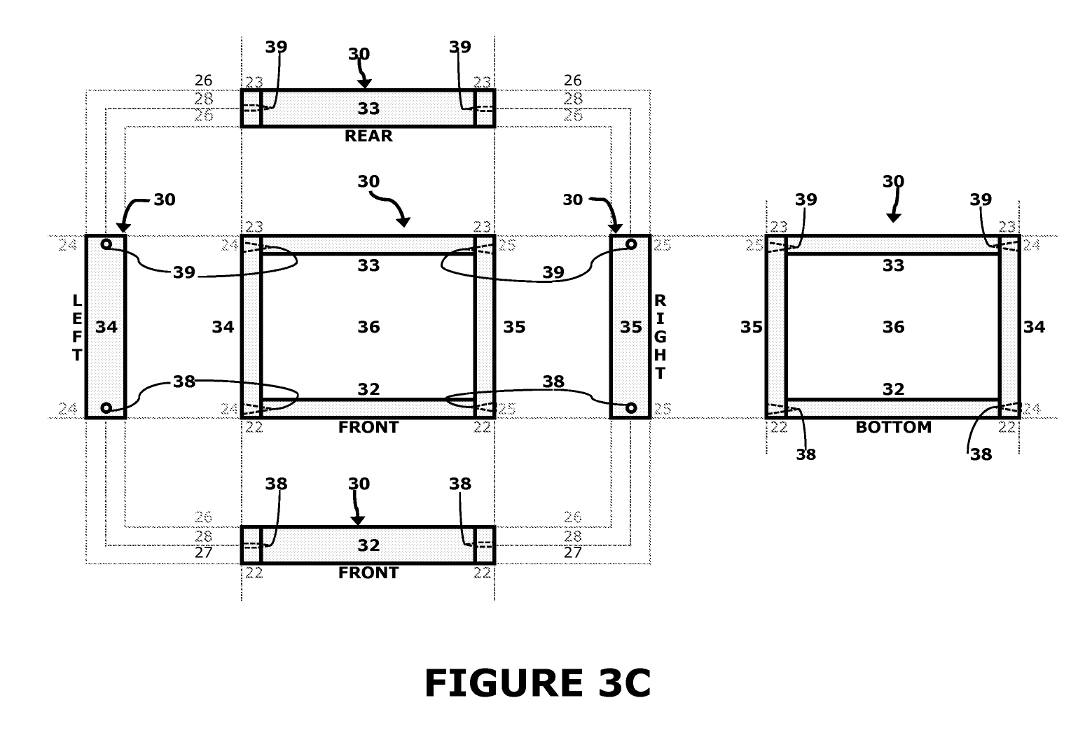

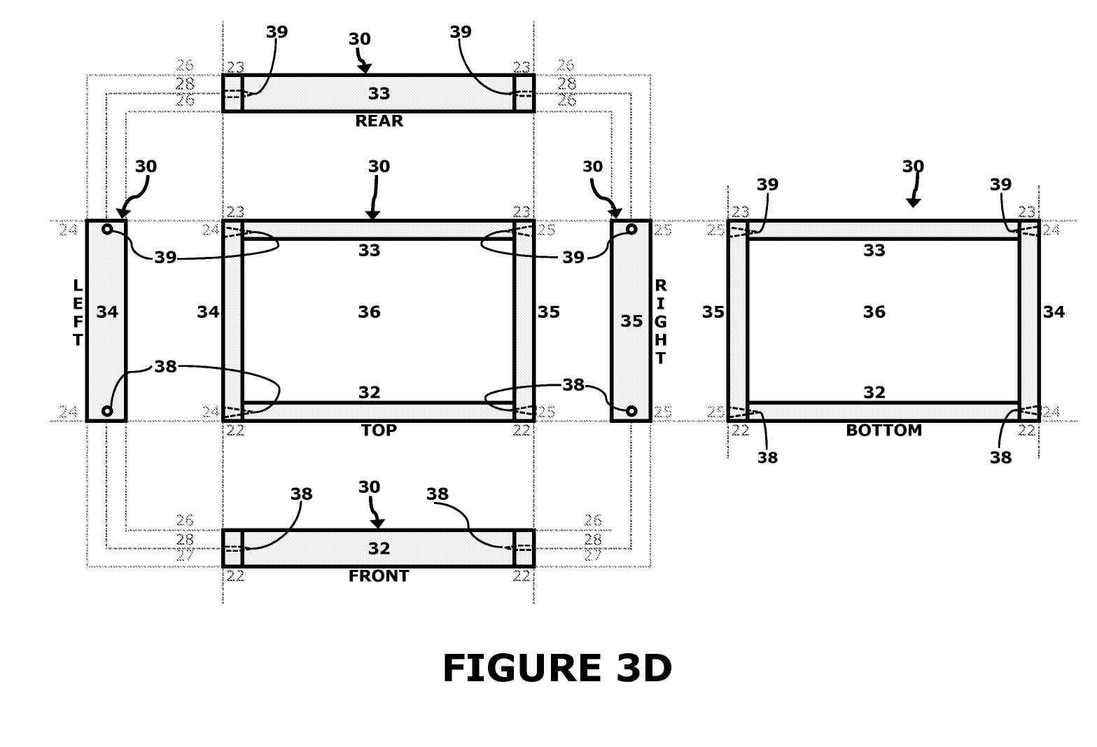

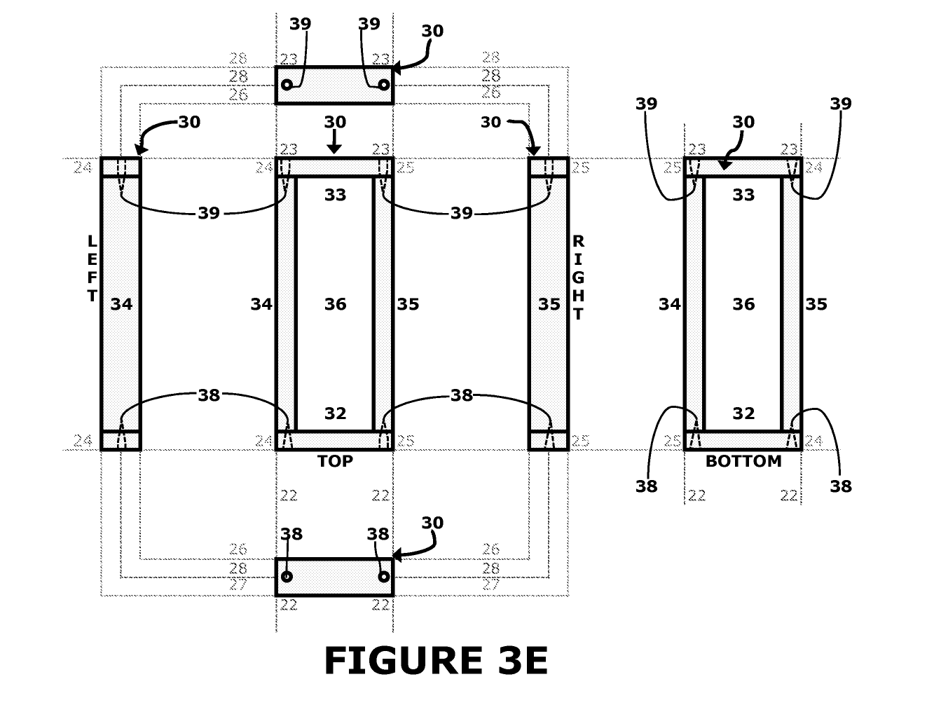

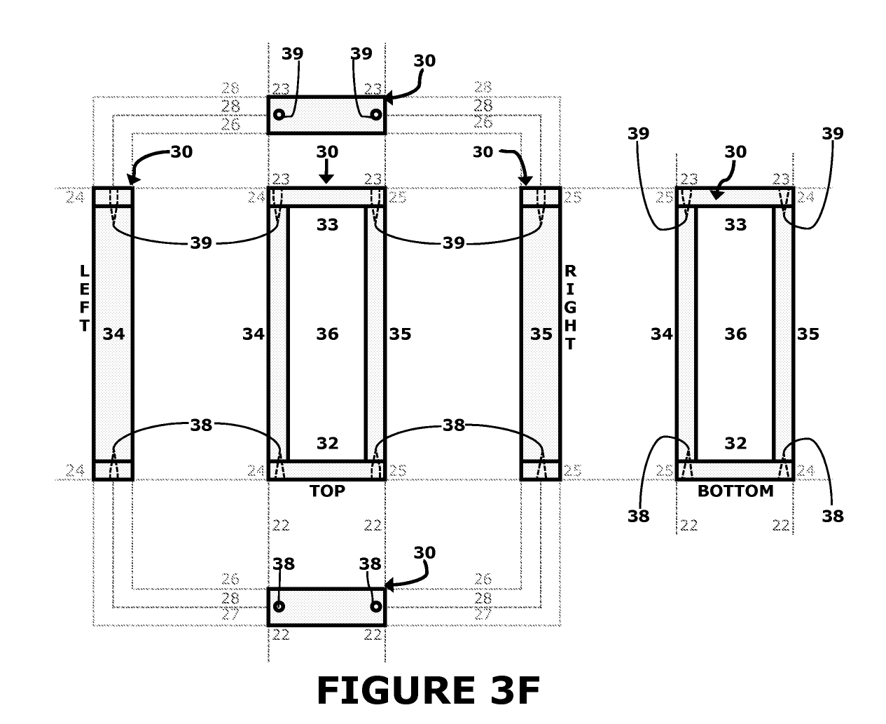

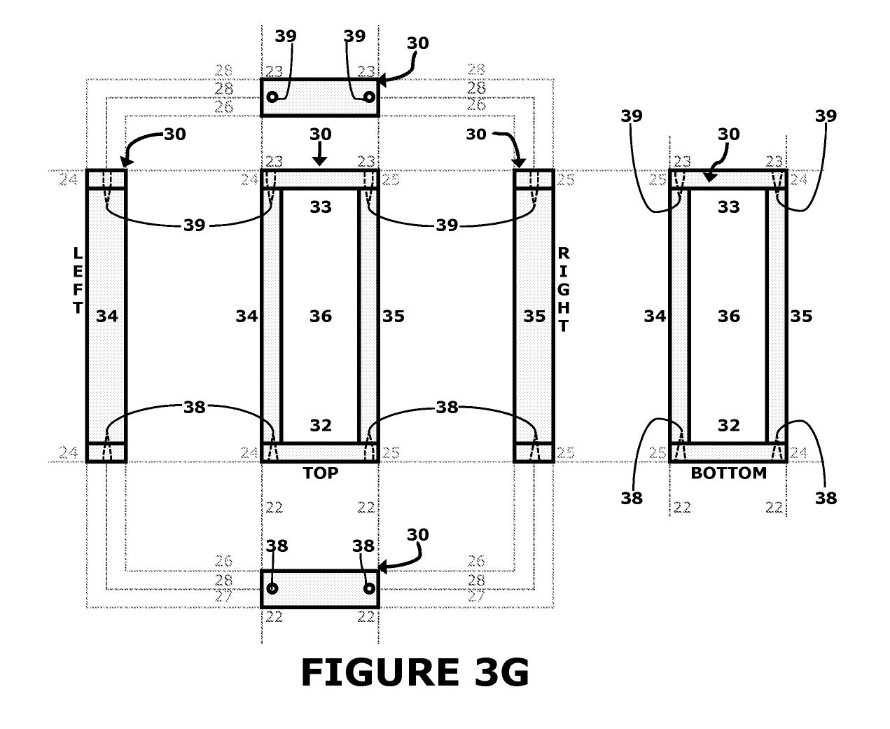

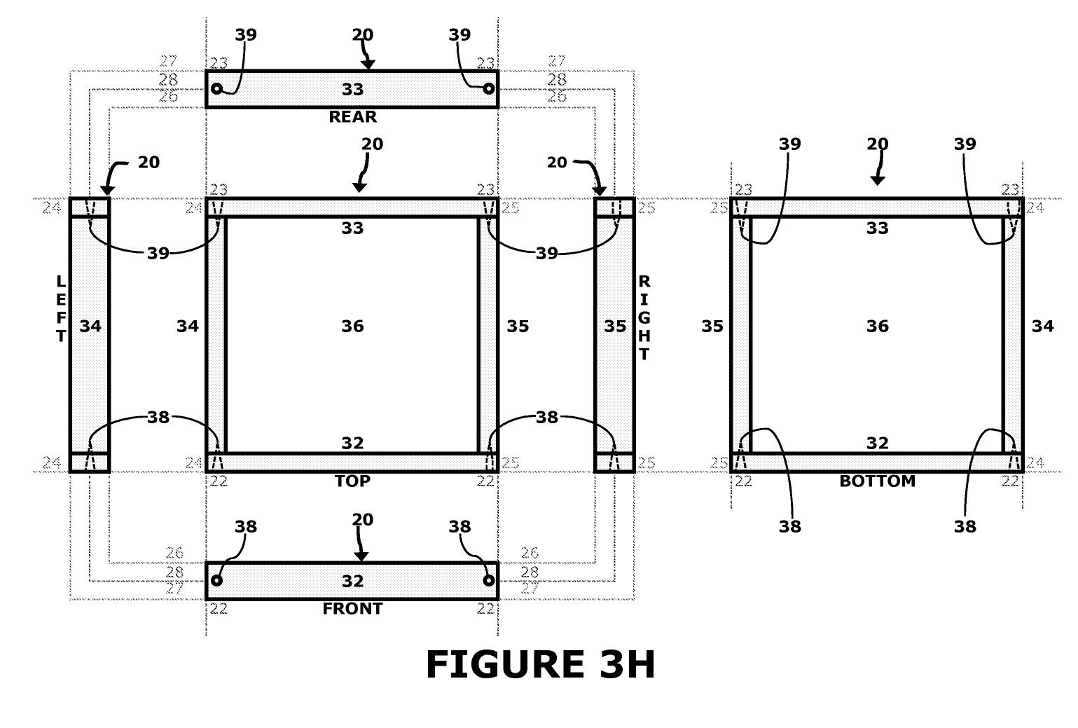

As shown in FIGS. 3A-3E, the frame 30 can comprise four members 32-35 which can be formed from comprise wooden boards having the same standard widths and depths

$$( e . g . , 1 \frac{1}{2}$$

inches by ¾ inch,

$$1 \frac{3}{4}$$

inch by ¾ inch,

$$2 \frac{1}{4}$$

inches by

$$1 \frac{1}{2}$$

inches, etc.). The frame members 32-35 can be arranged in a rectangular perimeter defining an area 36 which is, for example, at least six square inches, at least seven square inches, at least eight square inches, at least nine square inches, at least ten square inches, and/or less than twelve square inches. The rectangular shape of the area 36 can be slightly wide (see e.g., FIGS. 3A-3D), very narrow (see e.g., FIGS. 3E-3G), or square (see e.g., FIG. 3H).

The front and rear frame members 32-33 can have the same length, and the left and right frame members 34-35 can have the same length. The front and rear frame members 32-33 can be longer than the left and right frame members 34-35 (see e.g., FIGS. 3A-3D and 3H). Alternatively, the left and right frame members 34-35 can be longer than front and rear frame members 32-33 (see e.g., FIGS. 3E-3G).

Regardless of relative length, the front and rear end portions of the lateral frame members 34-35 can overlap lateral end portions of the front and rear frame members 32-33 (see e.g., FIGS. 3A-3D). Or the lateral end portions of the front and rear members 32-33 can overlap front and rear end portions of the lateral frame members 34-35 (see e.g., FIGS. 3E-3H). In either or any case the front frame member 32 and the rear frame member 33 can be secured to the lateral frame members 34-35 with fasteners 38 and 39 (e.g., wood screws).

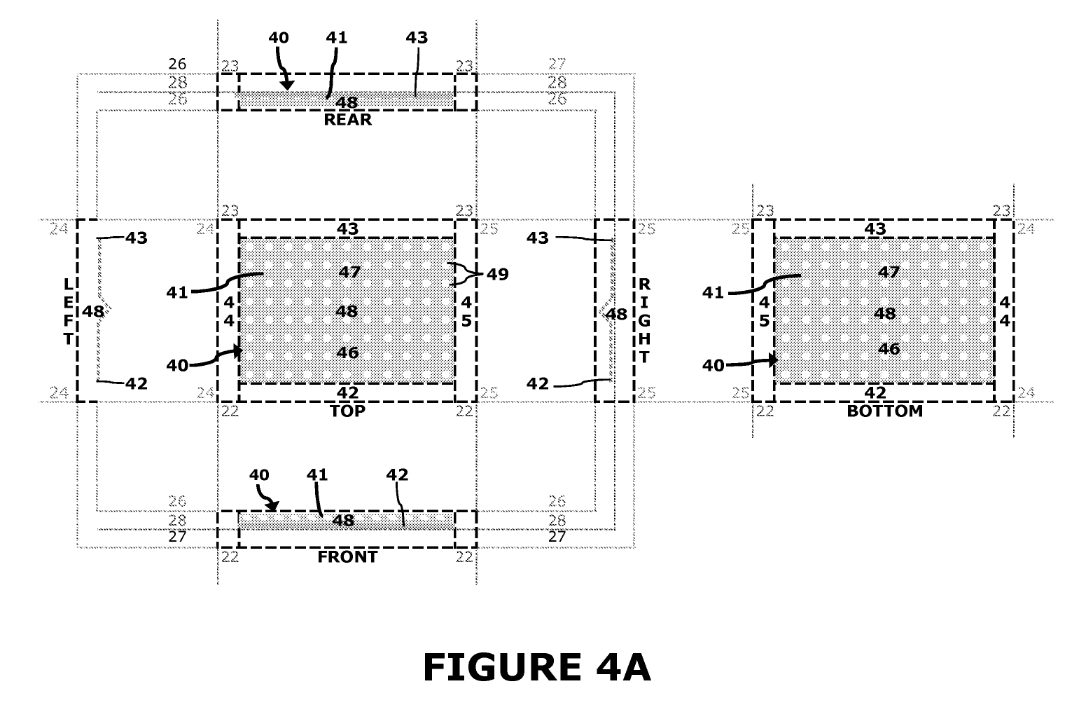

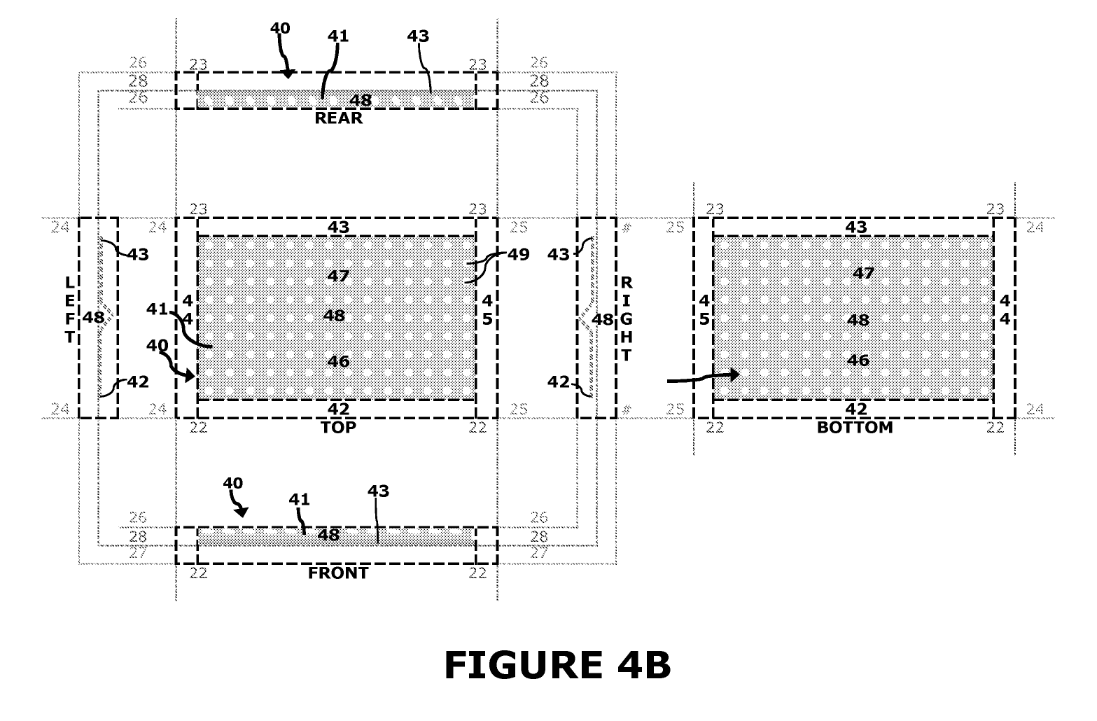

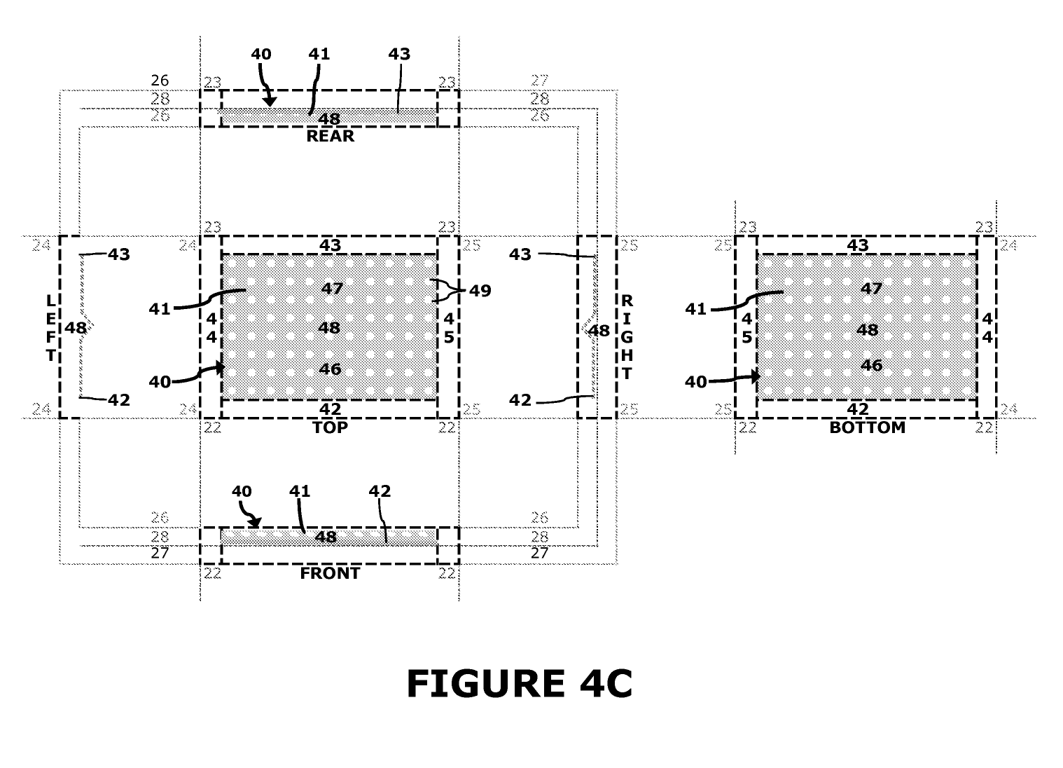

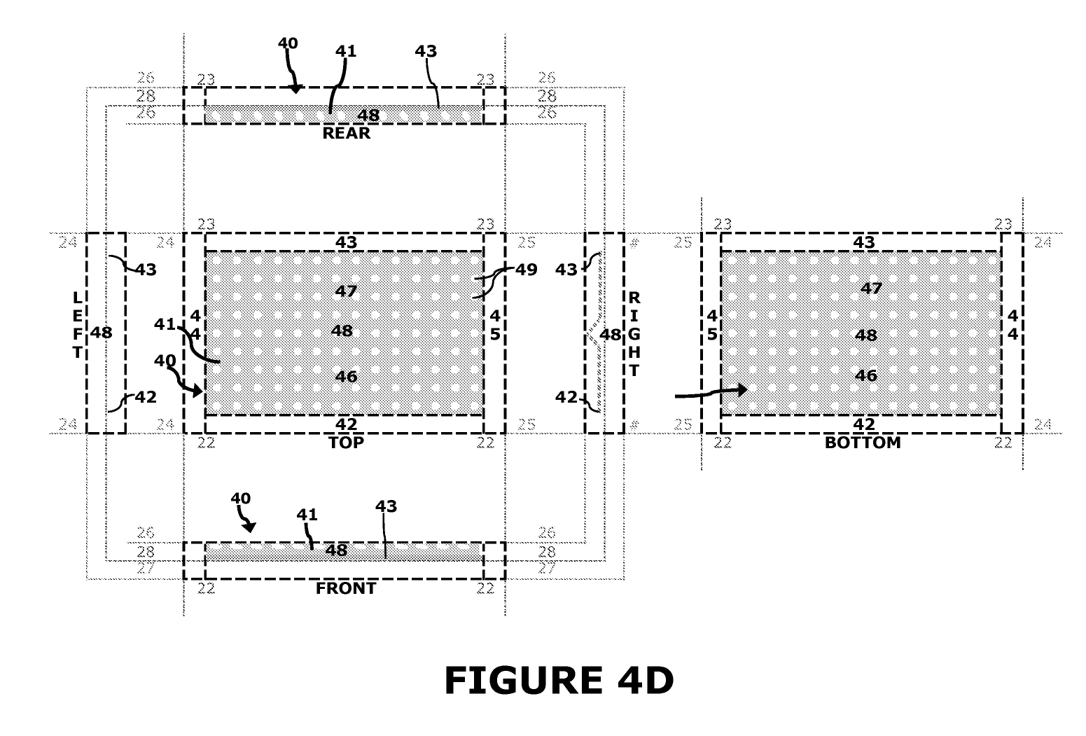

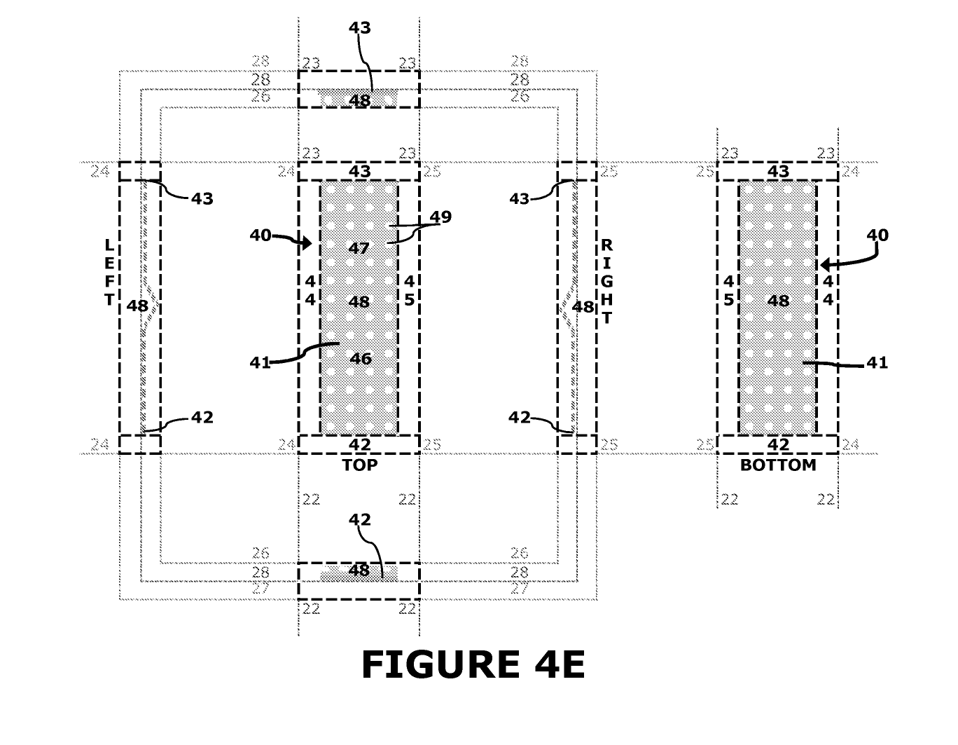

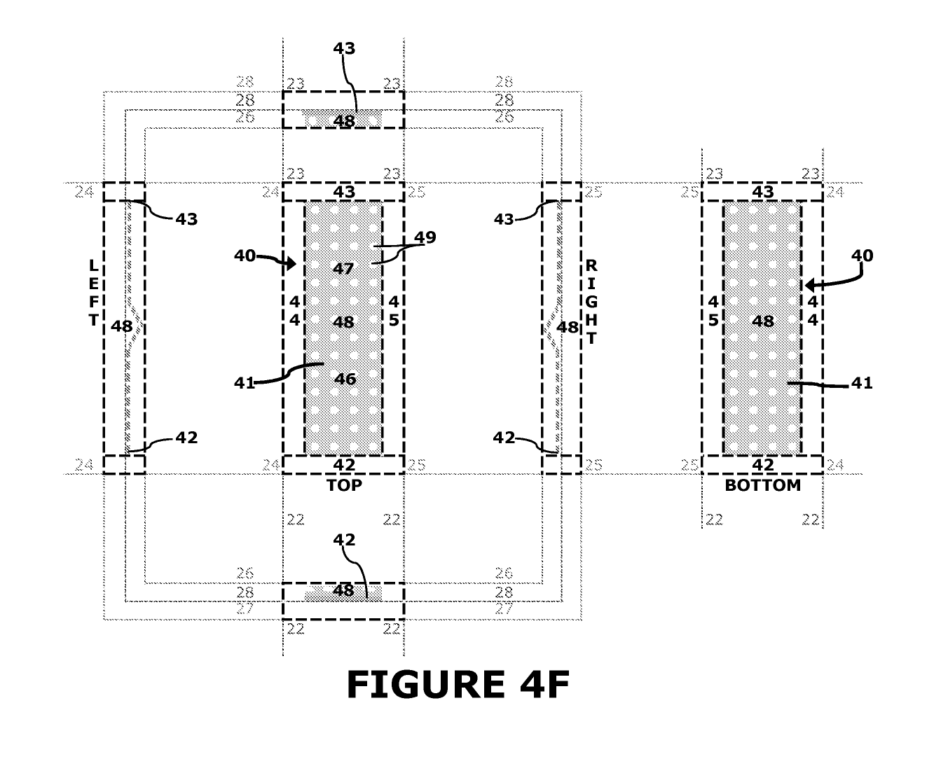

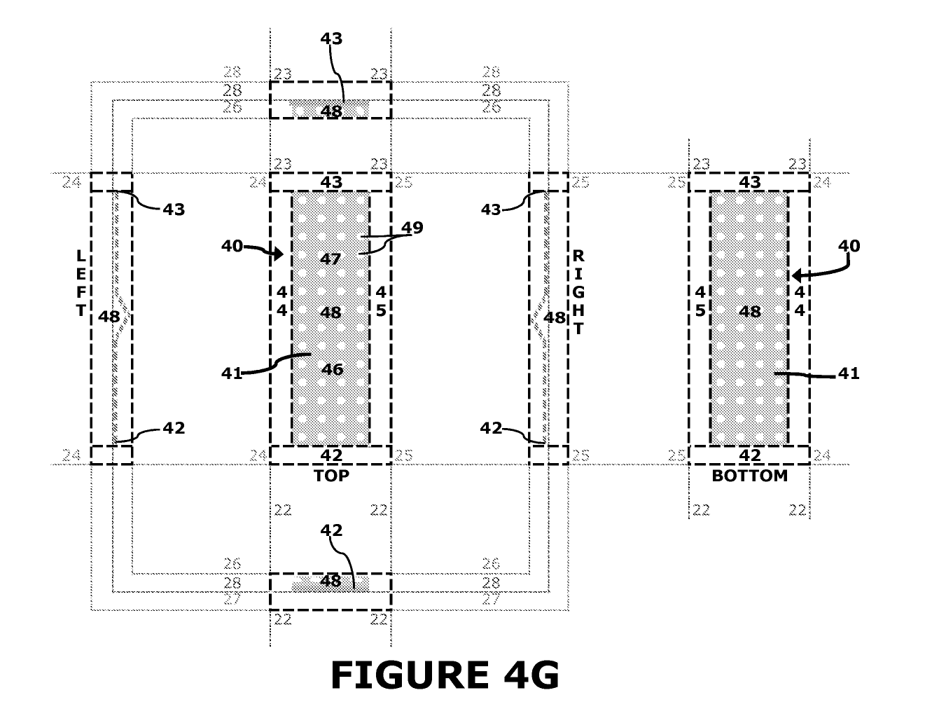

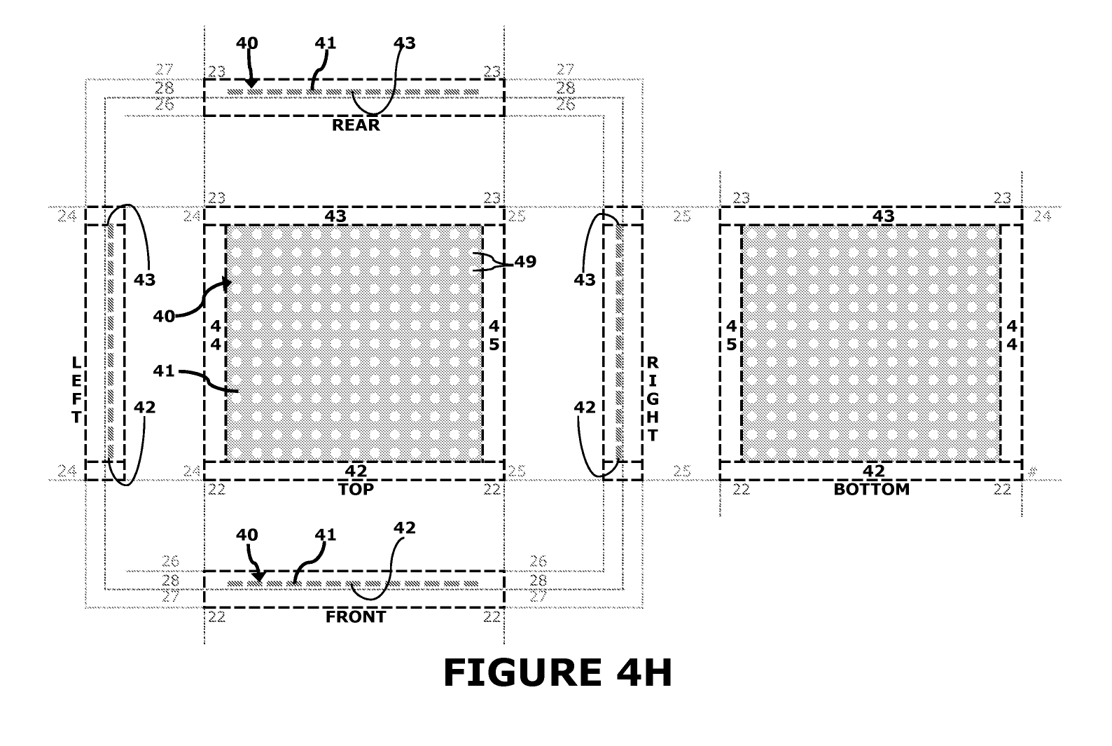

Referring to FIG. 4, the floor 40 can comprise a flooring sheet 41 having side edges 42-45 (e.g., front edge 42, rear edge 43, left edge 44, right edge 45) defining a perimeter sized to fit within the frame area 36. Specifically, for example, the front edge 42 can be situated immediately adjacent the front frame member 32, the rear edge 43 can be situated immediately adjacent the rear frame member 33, the left edge 44 can be situated immediately adjacent the left frame member 34, and the right edge 45 can be situated immediately adjacent the left frame member 35.

The sheet 41 can be provided with an array of holes 49 which are sized, and spaced to contain birdfeed with the tray 21 while at the same time allowing moisture (e.g., rain or melted snow) to drain therefrom. The holes 49 can be, for example, between about

$$\frac{1}{16}$$

inch and about ⅛ inch wide, and they can be spaced apart between about ⅛ to about ¼ inch. Typically, the hole array will result in the sheet 41 having between about 25% to about 45% open area.

The floor 40 preferably consists essentially of the sheet 41. And the sheet 41 is not secured to the frame 30 or to the railing 50 by fasteners or any other means. Accordingly, the floor 40 can be selectively removed from the base 20 and cleaned independently of the rest of the base 20.

The flooring sheet 41 can include a front stage section 46, a rear stage section 47, and a diverter section 48 therebetween (see e.g., FIGS. 4A-4G). The diverter section 48 is designed to urge birdseed onto the stage sections 46-47 and to this end has a ramped or triangular profile. Alternatively, the sheet 41 can have a substantially planar geometry without a diverter section (see e.g., FIG. 4H).

The sheet 41 can consist of a metal screen, metal or plastic plate, or a metal mesh. The sheet 41 is preferably characterized by no unturned edges. This construction will generally be cheaper to manufacture when compared to complicated edge geometries contoured to straddle or seat upon frame members.

If the sheet 41 is a screen, the holes 49 can constitute the voids defined by the gauge intersections. If the sheet 41 is a plate, the holes 49 can constitute perforations cut, punched, or otherwise formed therein. If the sheet 41 is a mesh, the holes 49 can constitute expanded slits. With a screen, the holes 49 will often be rectangular in shape. With a plate or mesh, the hole shape will depend upon fabrication, but will usually be circular, oval, diamond, or polygonal in shape.

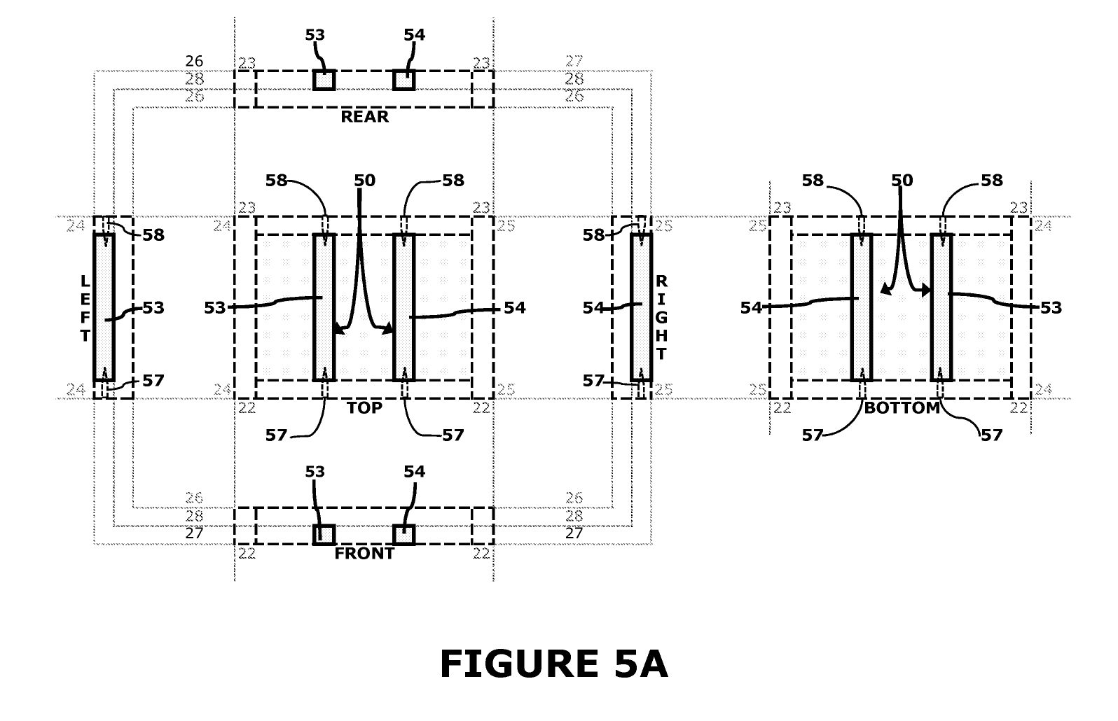

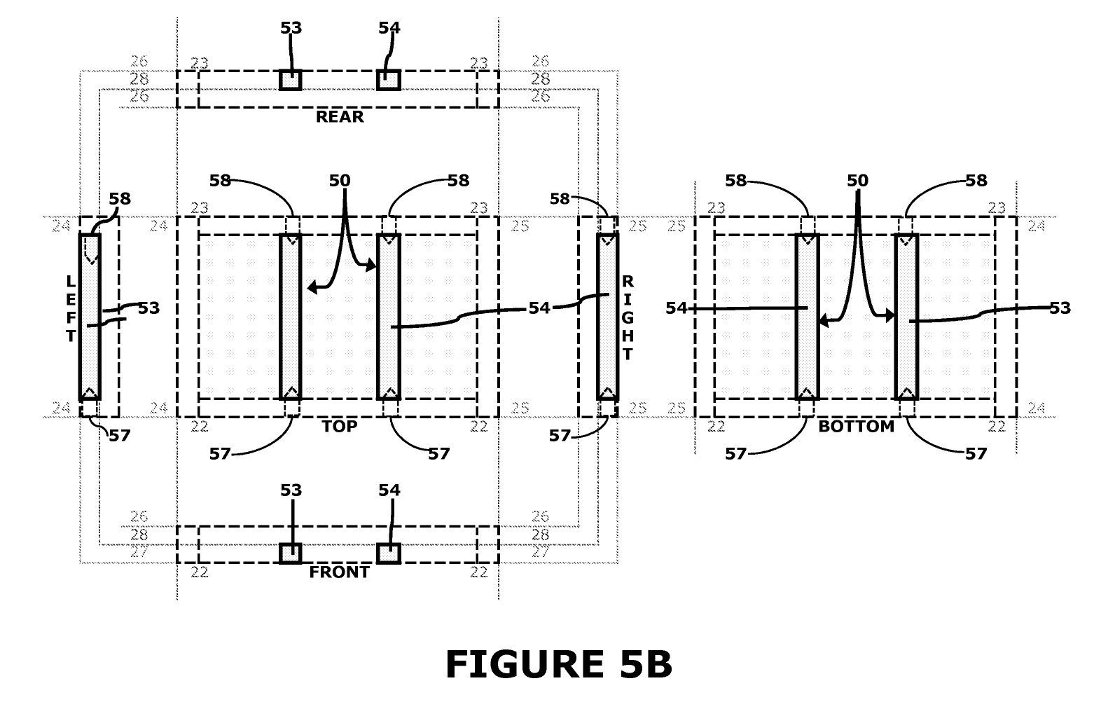

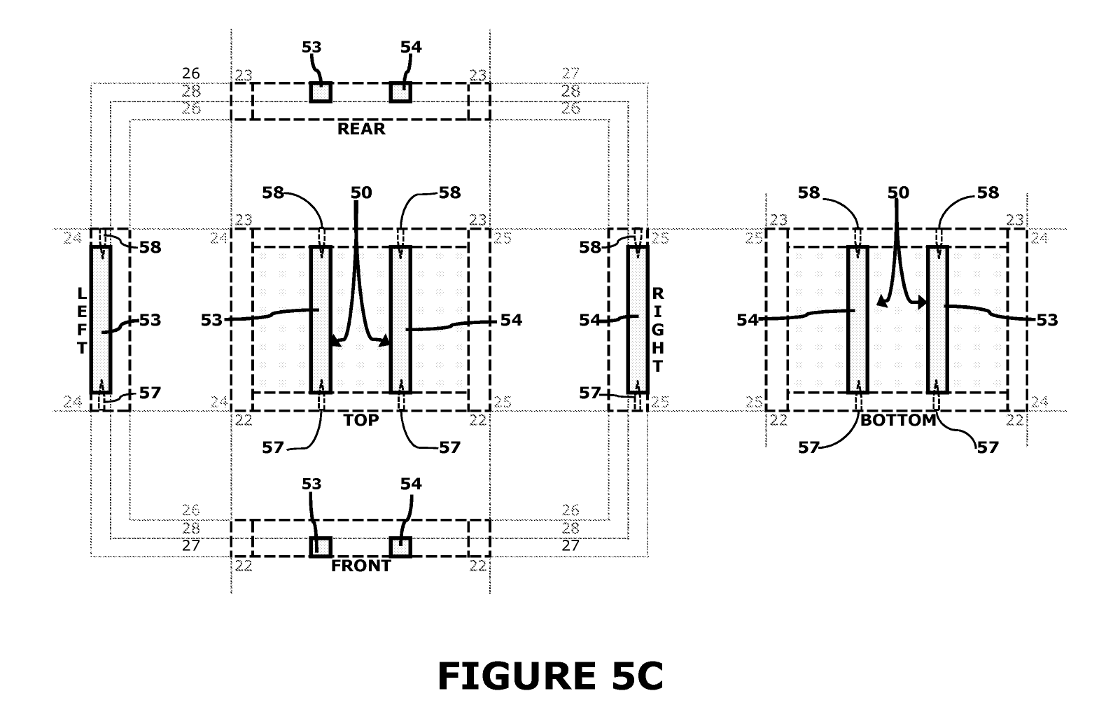

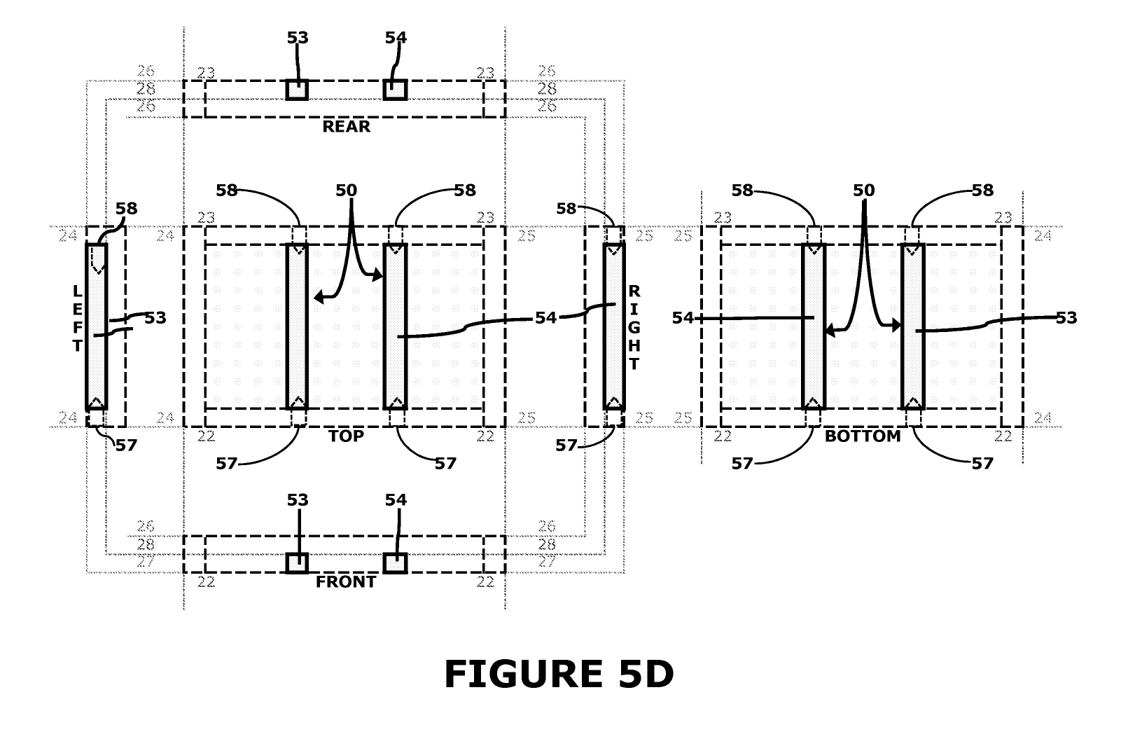

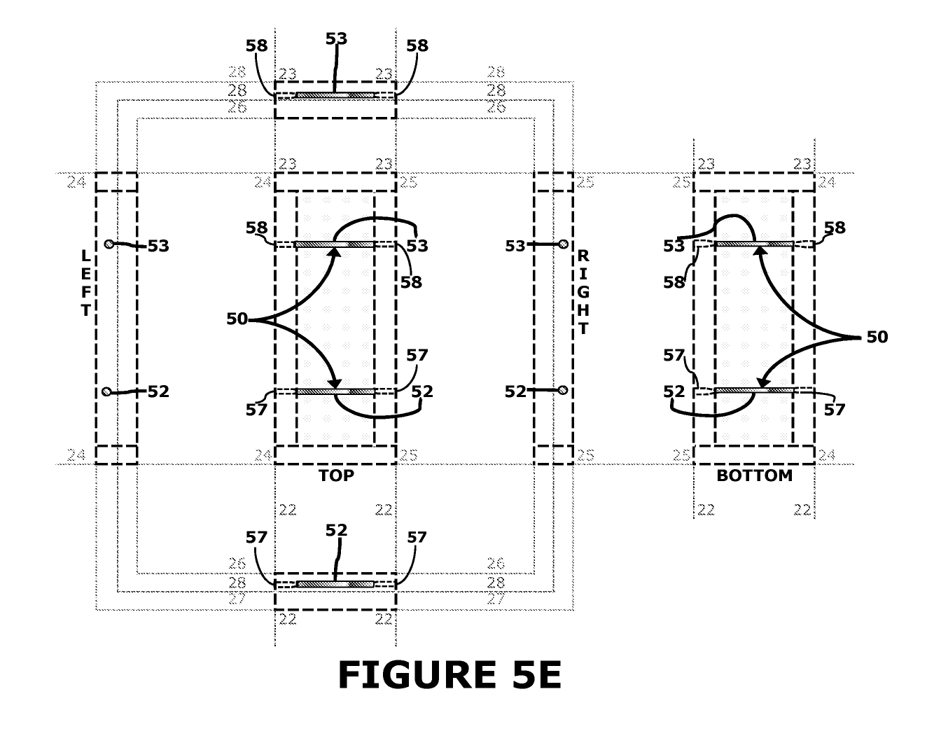

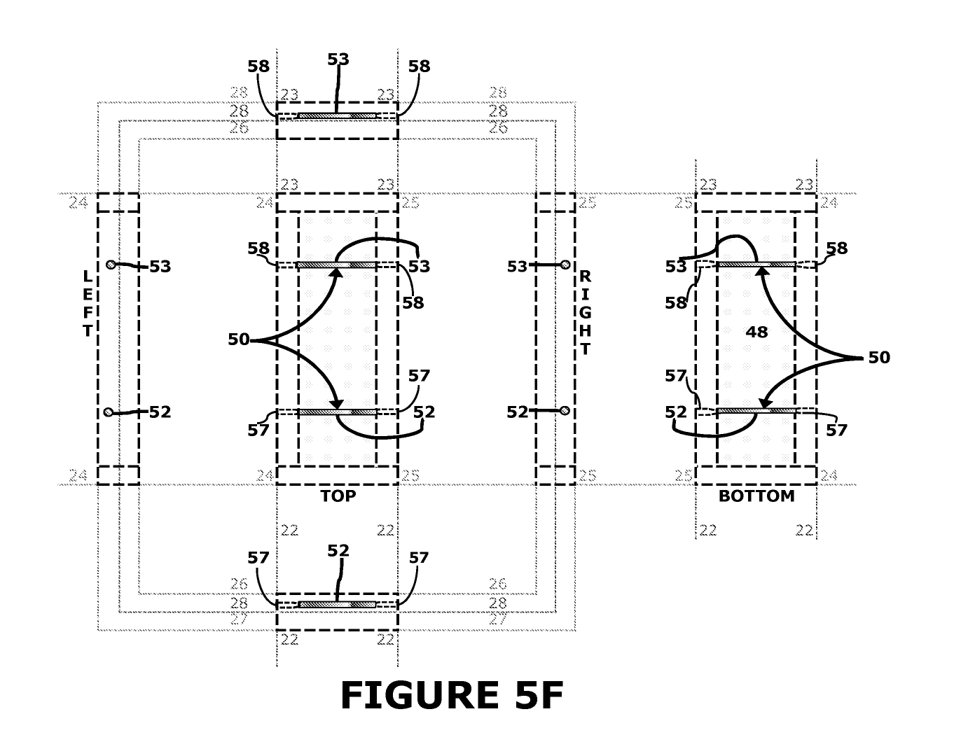

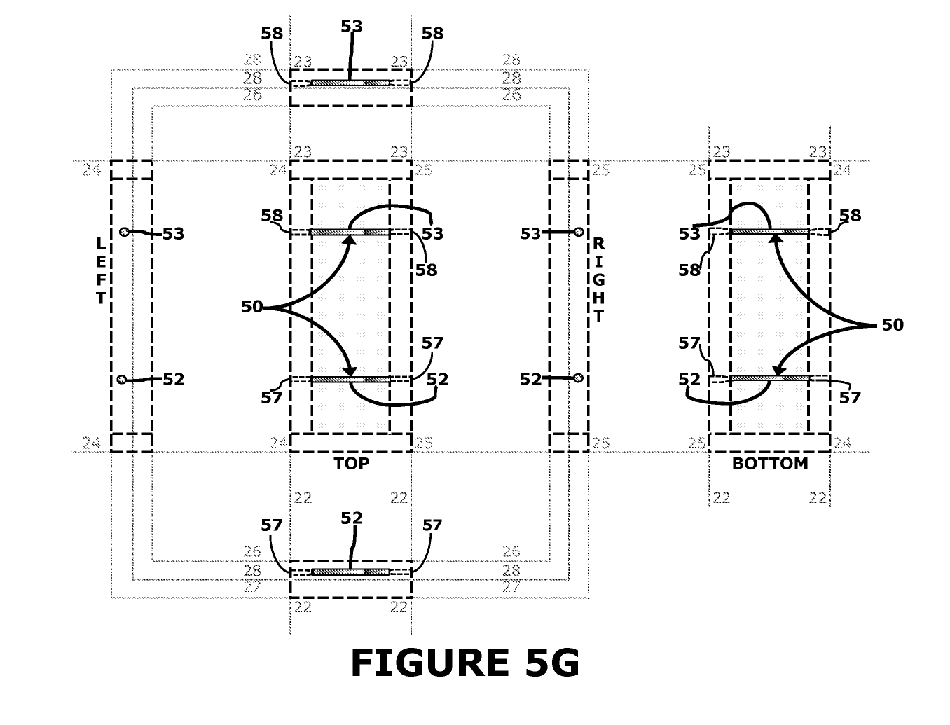

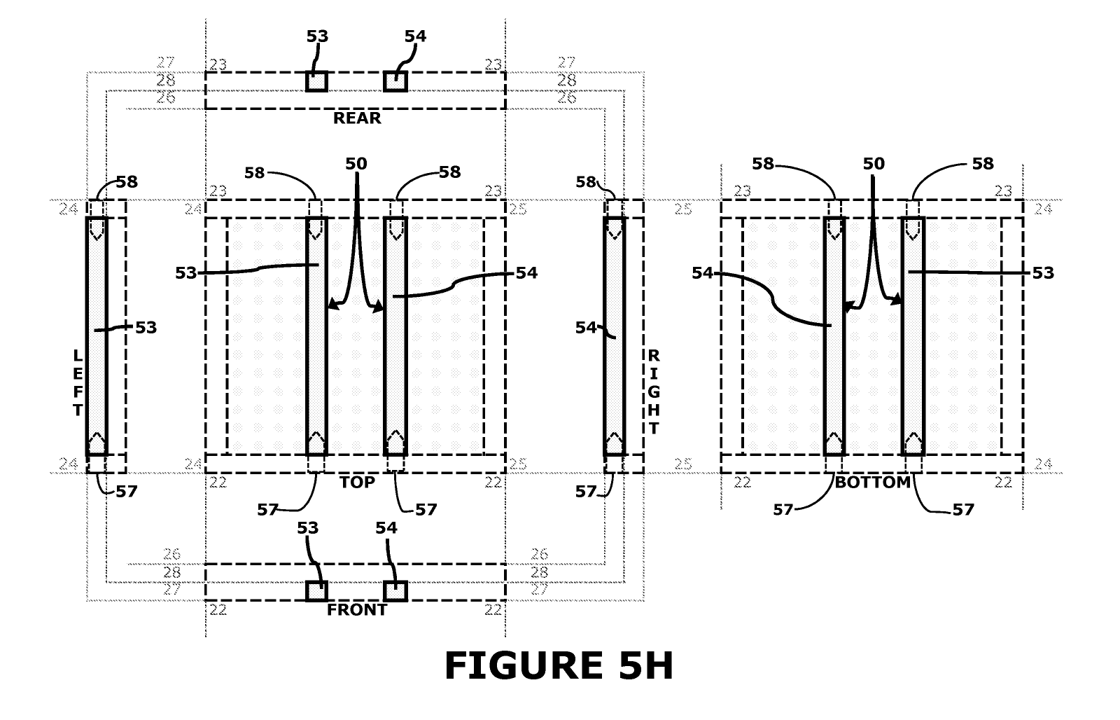

Referring to FIG. 5, the railing 50 is adapted to stance the floor 40 relative to the rest of the base 20 so that it can form the bottom boundary of the tray 21. The railing comprises railing members which can be left and right members 54-55 (see e.g., FIGS. 5A-5D and 5H) or which can be front and rear members 52-53 (see e.g., FIGS. 5E-5G). Additionally or alternatively, the railing members can be formed by wooden boards (see e.g., FIGS. 5A-5D and 5H) or metal rods (see e.g., FIGS. 5E-5G).

Left and right rail members 54-55 can extend between the front and rear frame members 32-33 and can be attached thereto with fasteners 56-57. The rail members 54-55 can be disposed parallel to each other and to the left and right frame members 34-35. They can be separated from each other by a nonzero rail-to-rail distance Dᵣₐᵢₗₛ. And each rail member 54/55 can be separated from the adjacent frame member 34/35 by a nonzero rail-to-frame distance D_{frame}. (See e.g., FIGS. 5A-5D and 5H.)

Similarly, front and rear rail members 52-53 can extend between the left and right frame members 33-34 and be attached thereto with fasteners 56-57. The front-rear rail members 52-53 can be disposed parallel to each other and parallel to the front and rear frame members 32-33. They can be separated by a nonzero rail-to-rail distance Dᵣₐᵢₗₛ and separated from the respective frame members 32-33 by a nonzero rail-to-frame distance D_{frame}. (See e.g., FIGS. 5E-5G.)

In any case, the railing members are situated below the floor 40 (i.e., below the tray's bottom boundary 28) but not below the frame 30 (i.e., not below the base's bottom boundary 27).

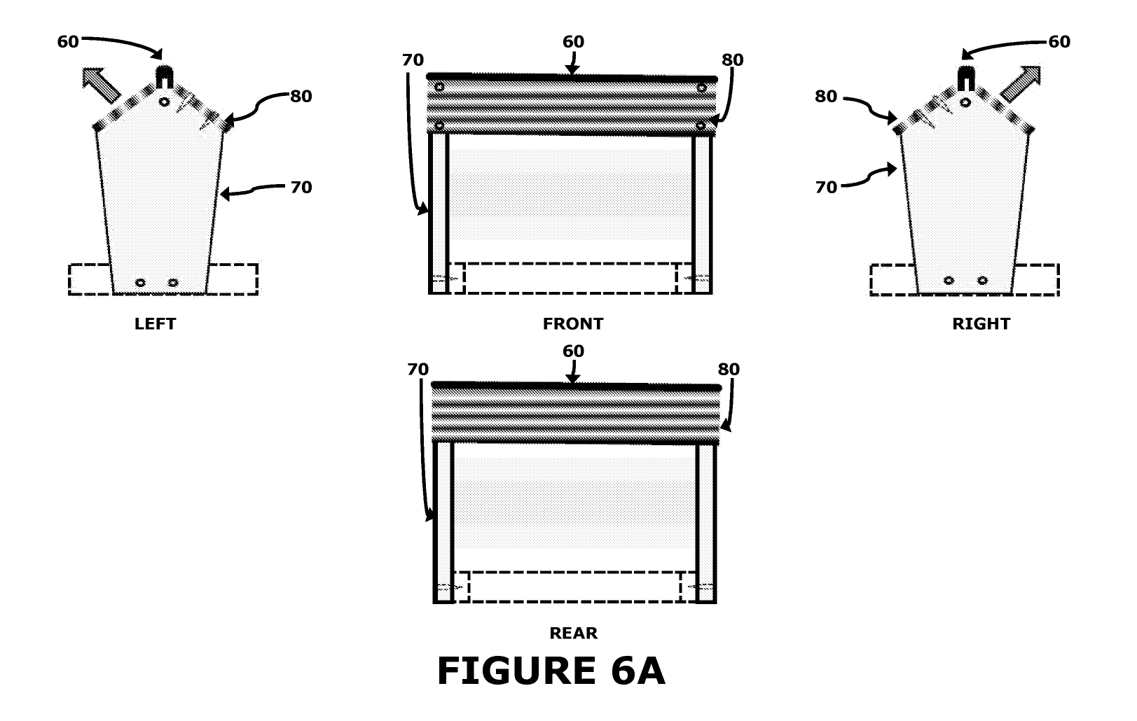

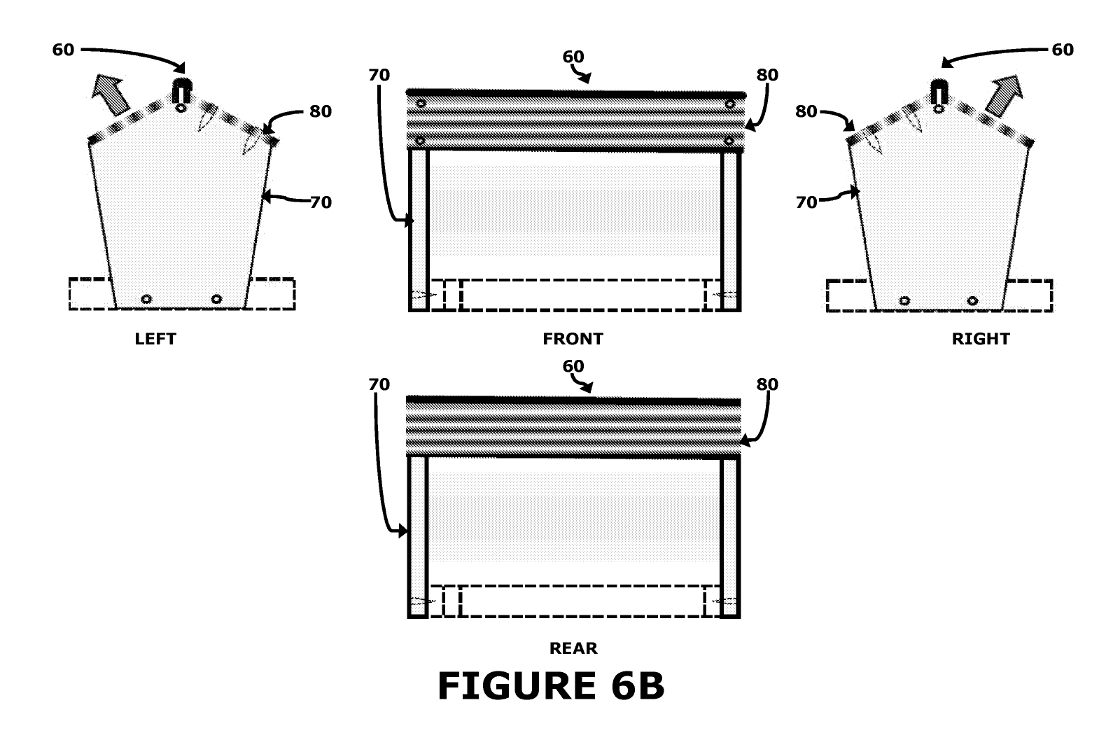

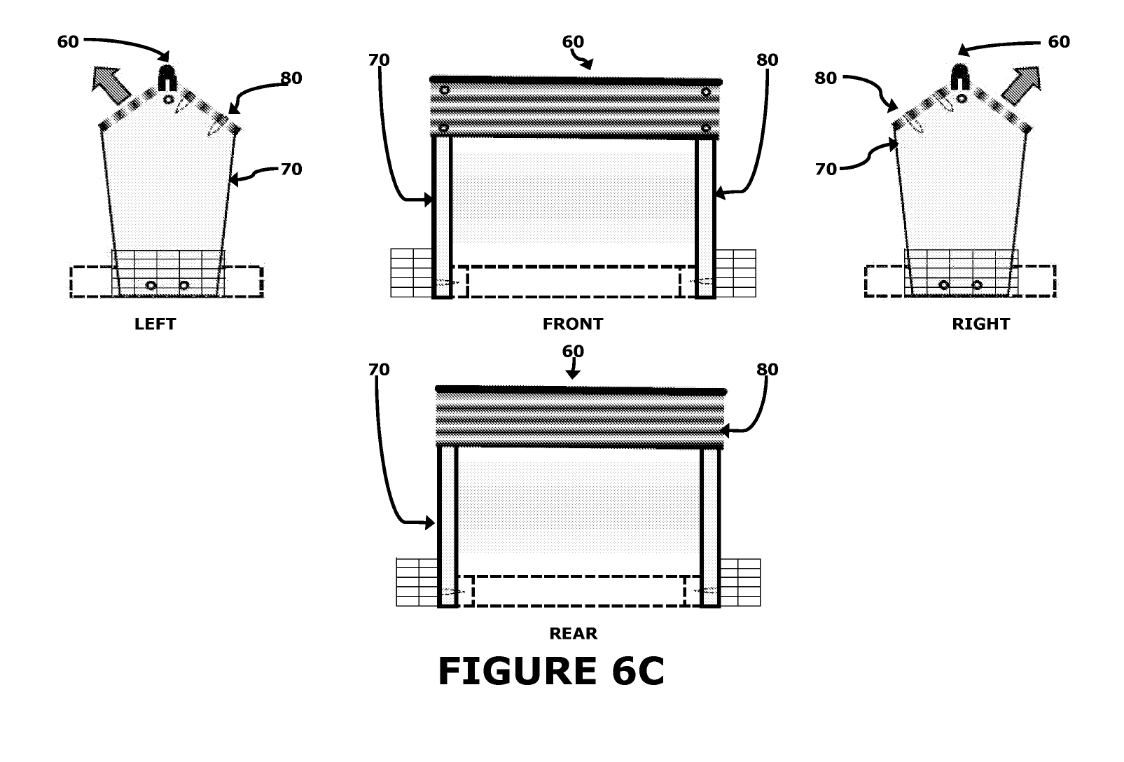

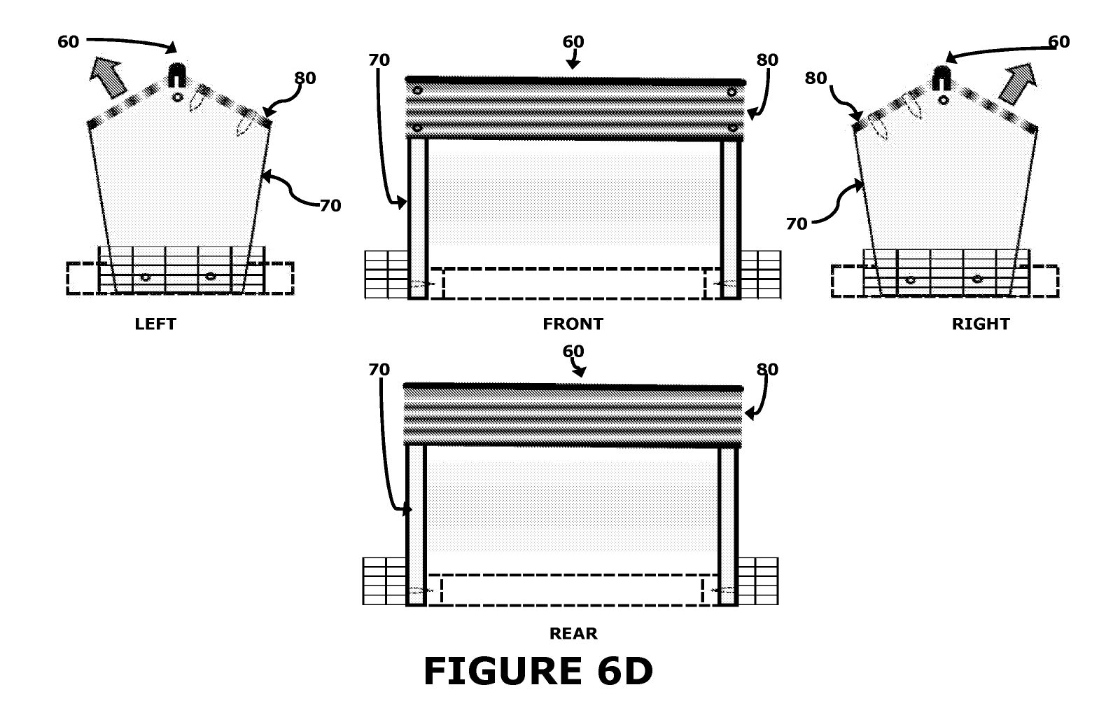

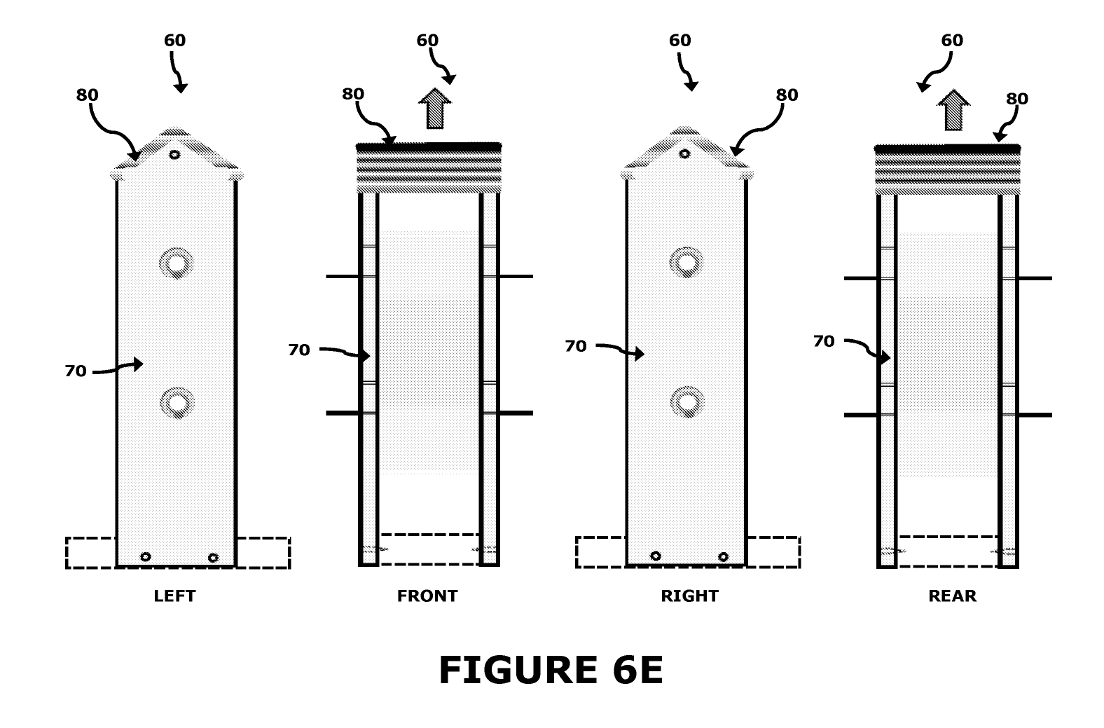

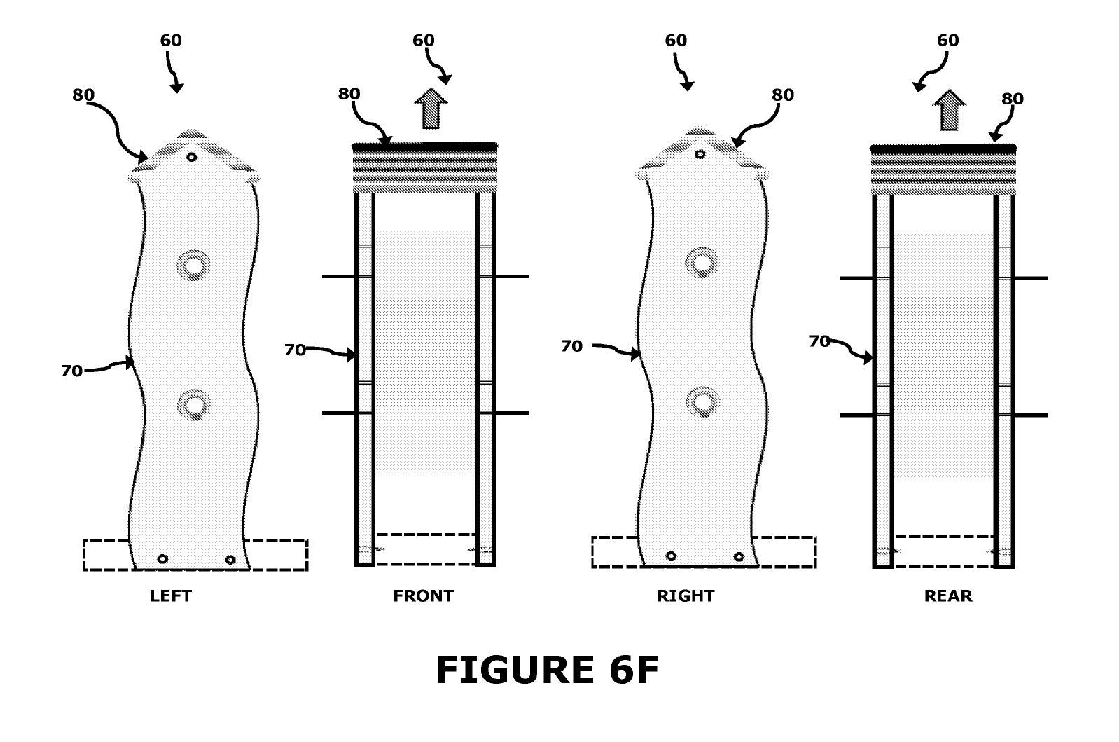

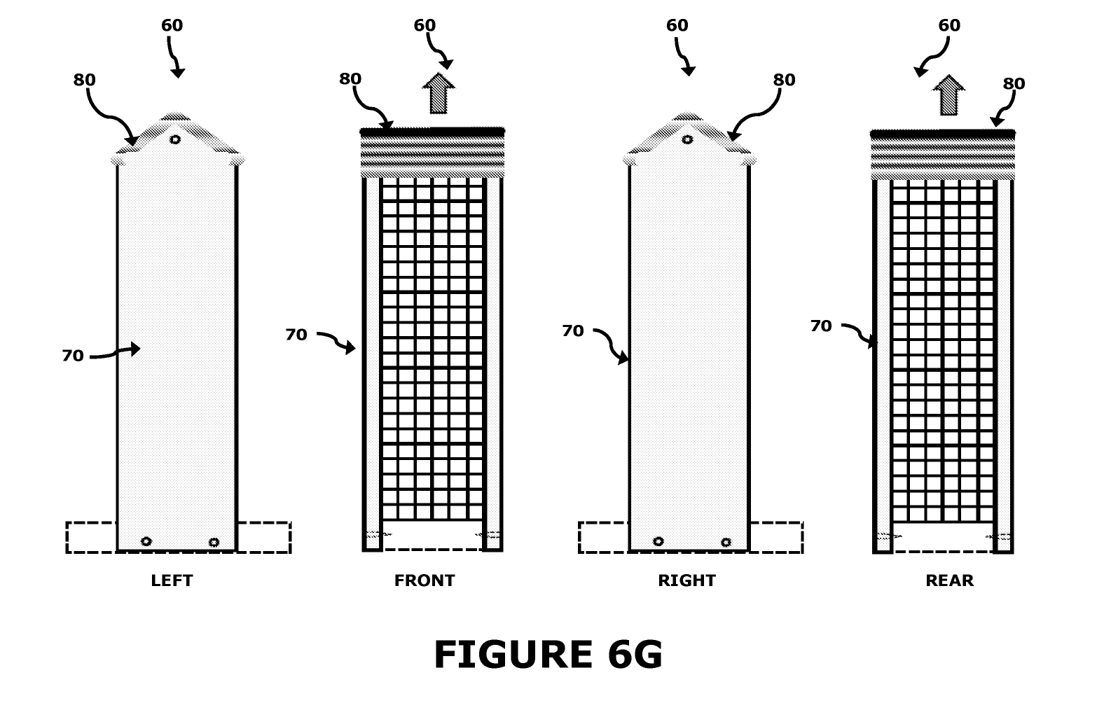

Referring briefly back to FIGS. 1A-1G and then to FIGS. 6A-6G, the birdfeeders 10 can include a hopper 60 having a compartment 61 for storing birdfeed to replenish the tray 21. The hopper 60 can comprise a housing 70 and a roof 80.

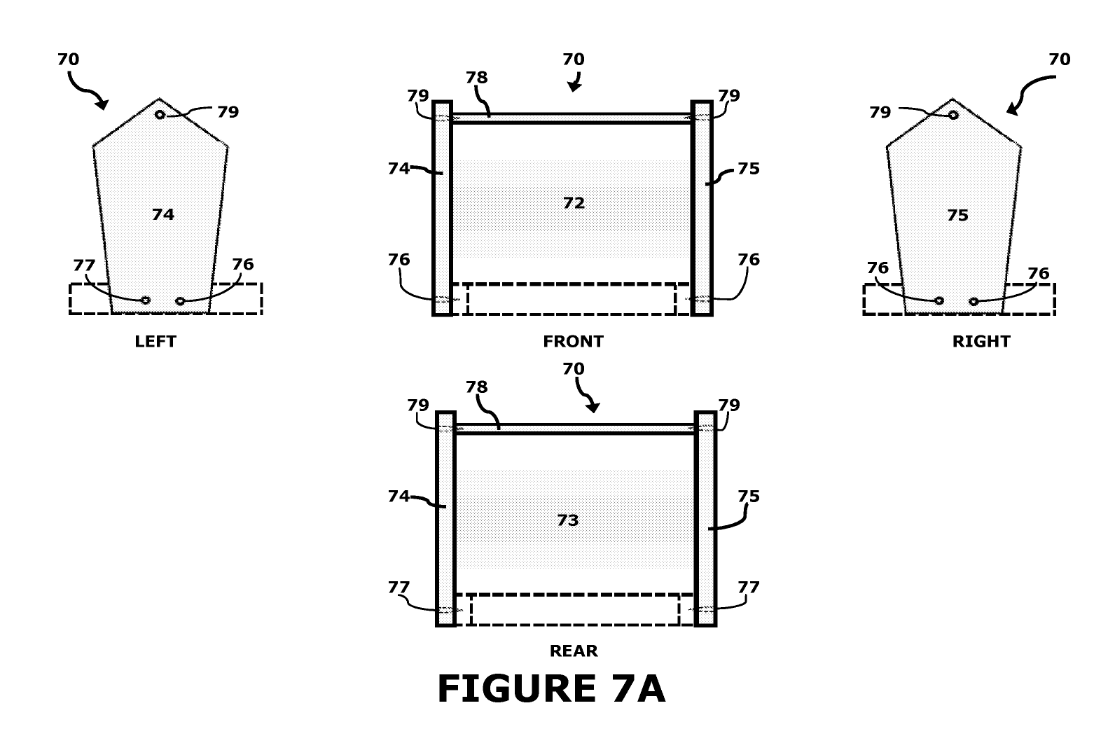

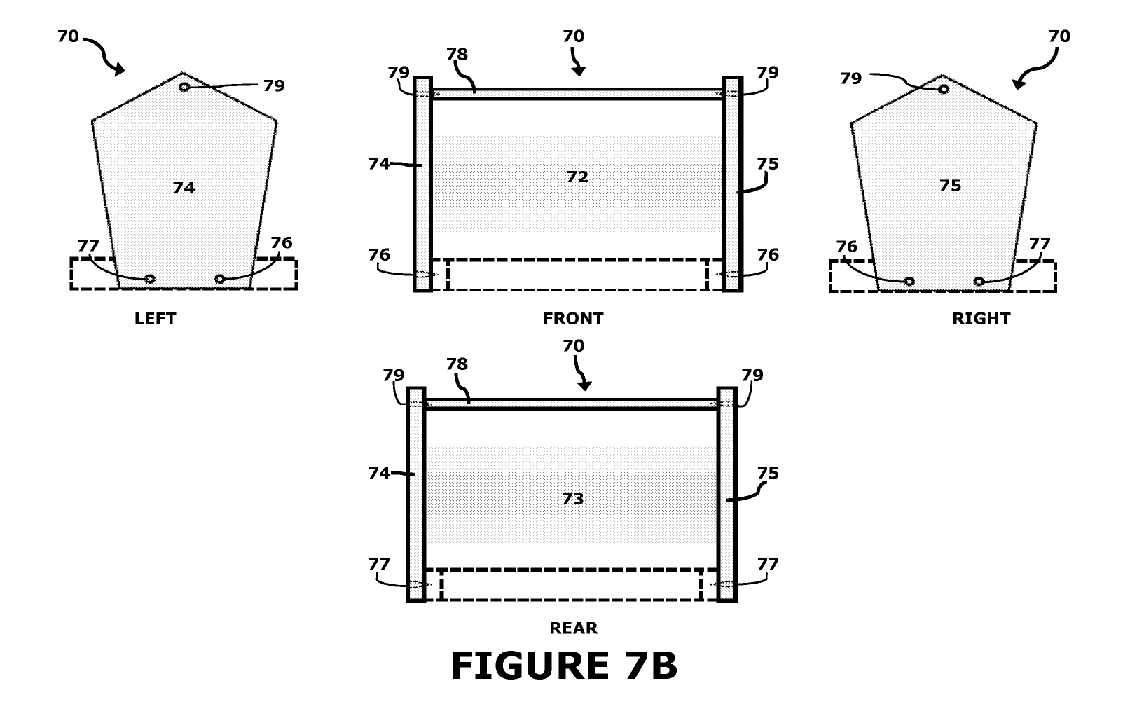

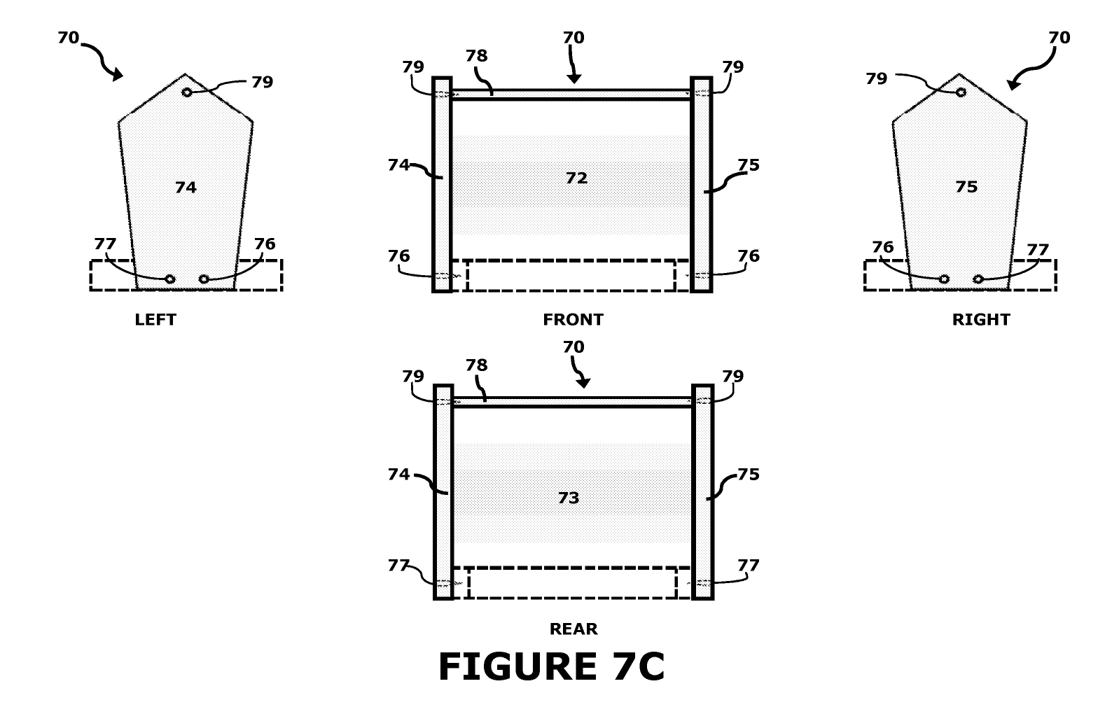

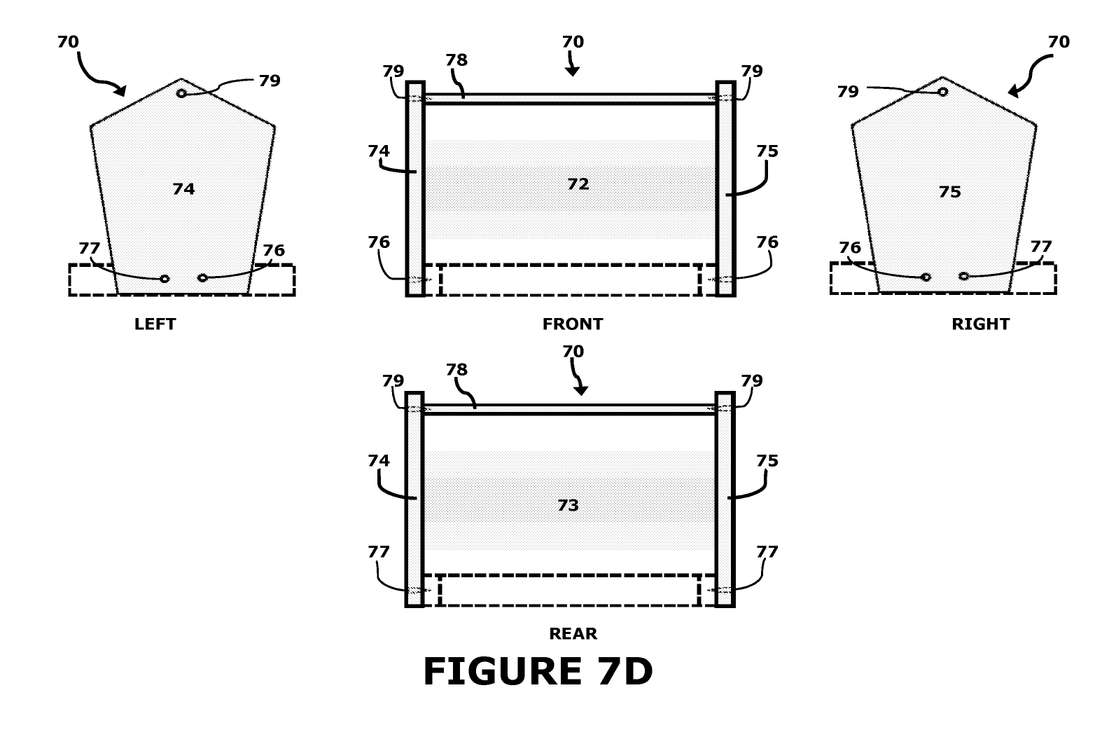

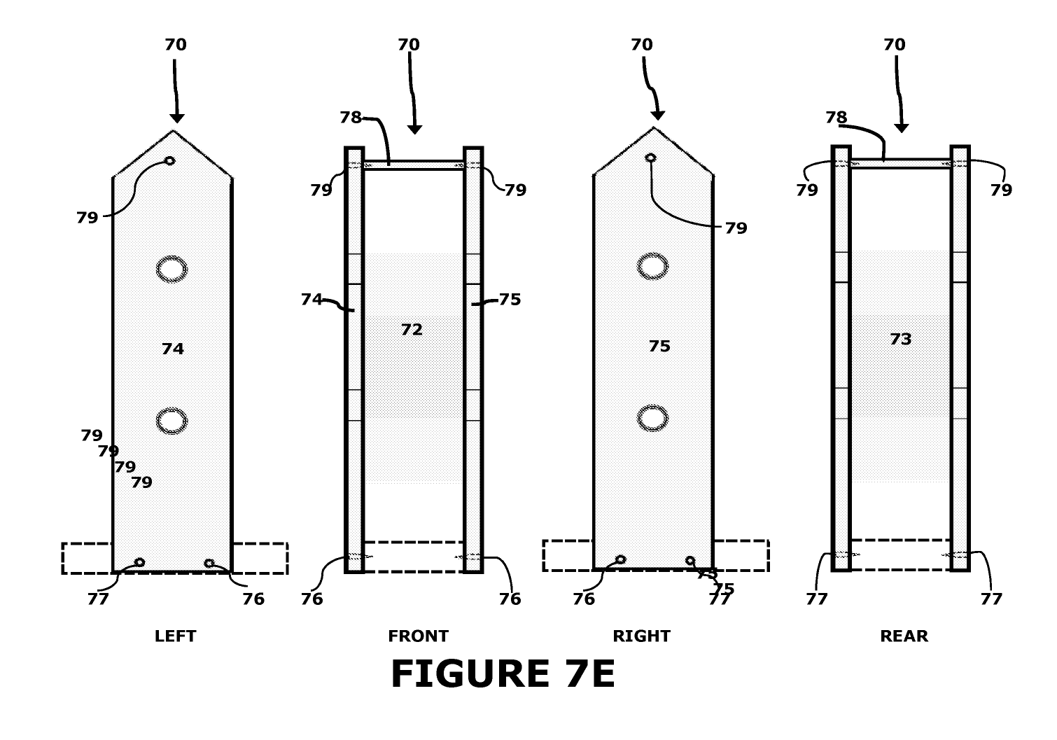

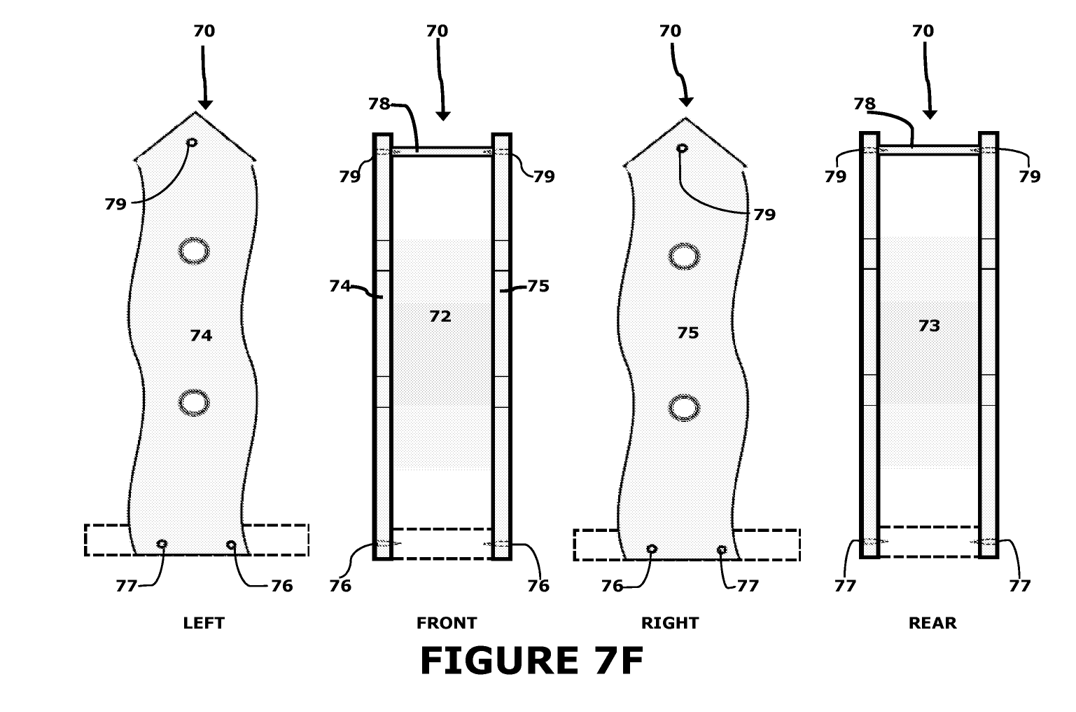

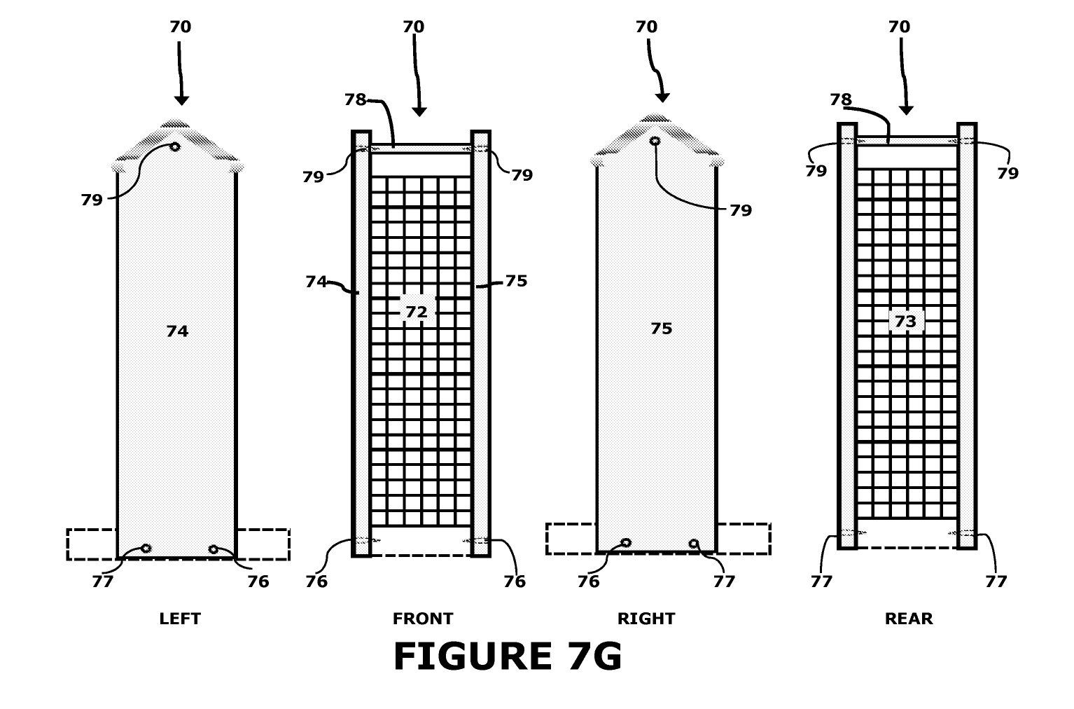

Referring to FIGS. 7A-7G, the housing 70 includes panels 72-75 surrounding the compartment 61. The panels 72-73 can comprise transparent panes (see e.g., FIGS. 7A-7F) of they can comprise mesh screens (see e.g., FIG. 7G). The panels 74-75 can comprise wooden walls having pentagonal, rectangular, or other regular or irregular shapes.

The housing panels 72-75 are attached to the base 20 in such a manner that they do not extend below its bottom boundary 27. For example, the panels 74-75 can be attached to the left and right frame members 34-35 via fasteners 76-77. The lateral edges of the front-back panels 72-73 can be received within slots along the front-back edges of the panels 74-75.

The housing 70 can further comprise a joist 78 spanning between upper portions of the panels 74-75 and attached thereto by fasteners 79 (e.g., wood screws).

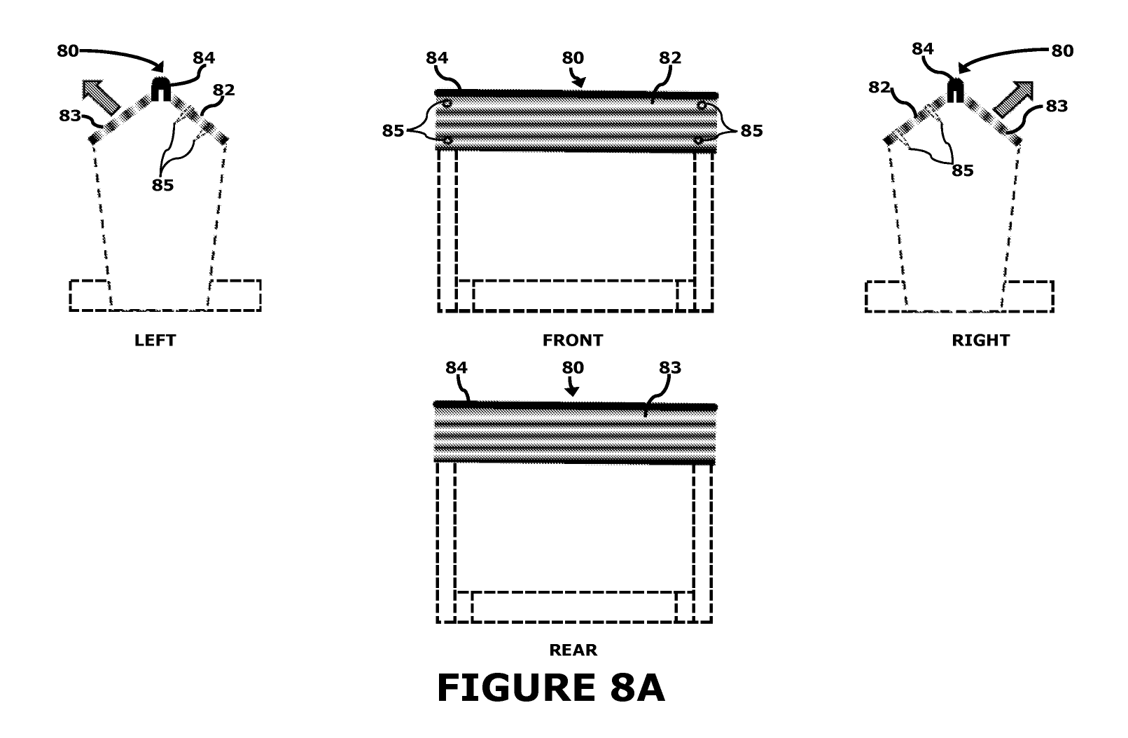

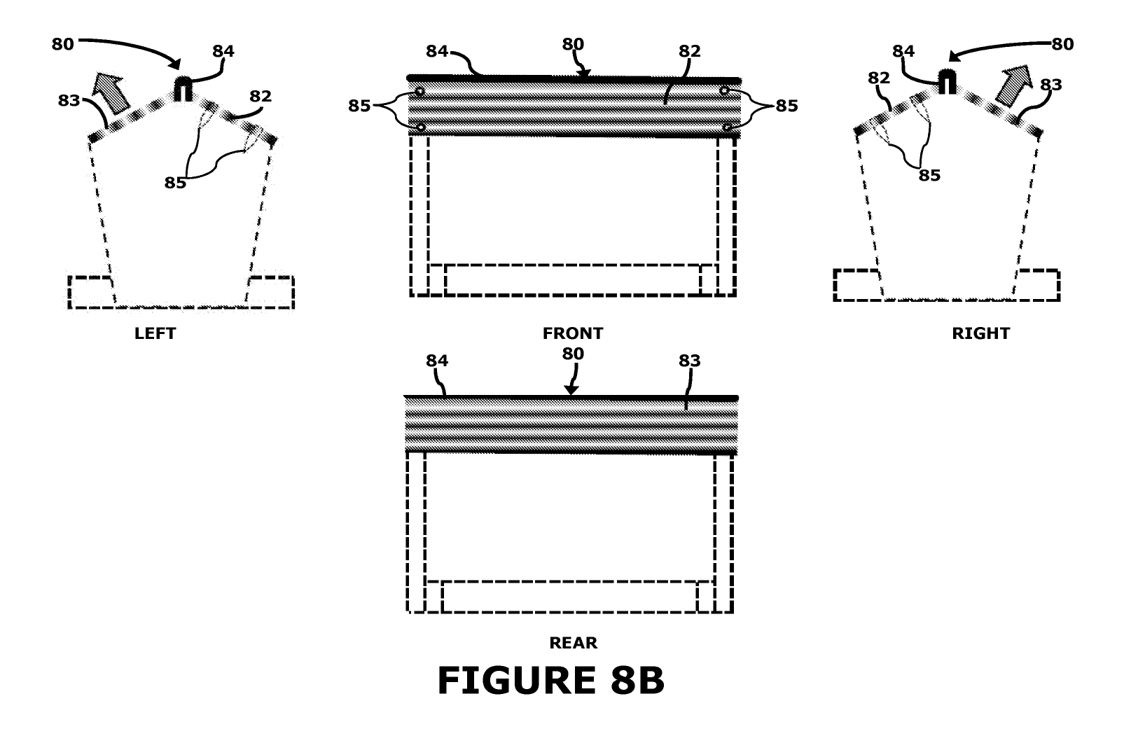

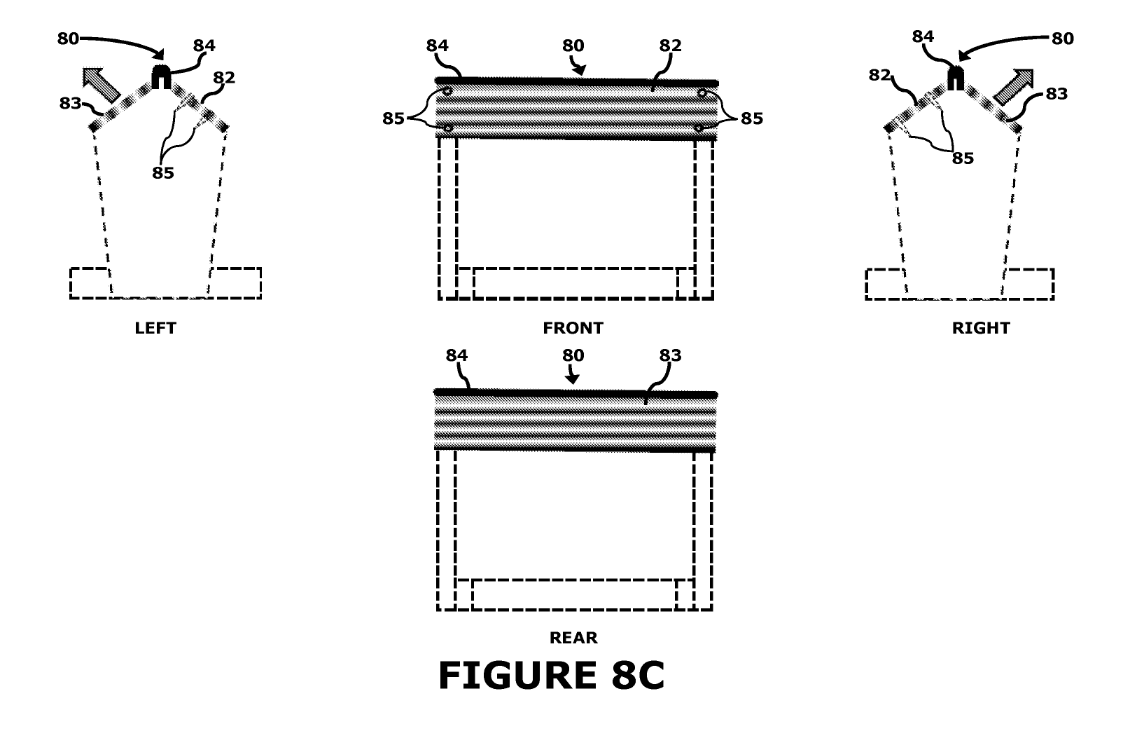

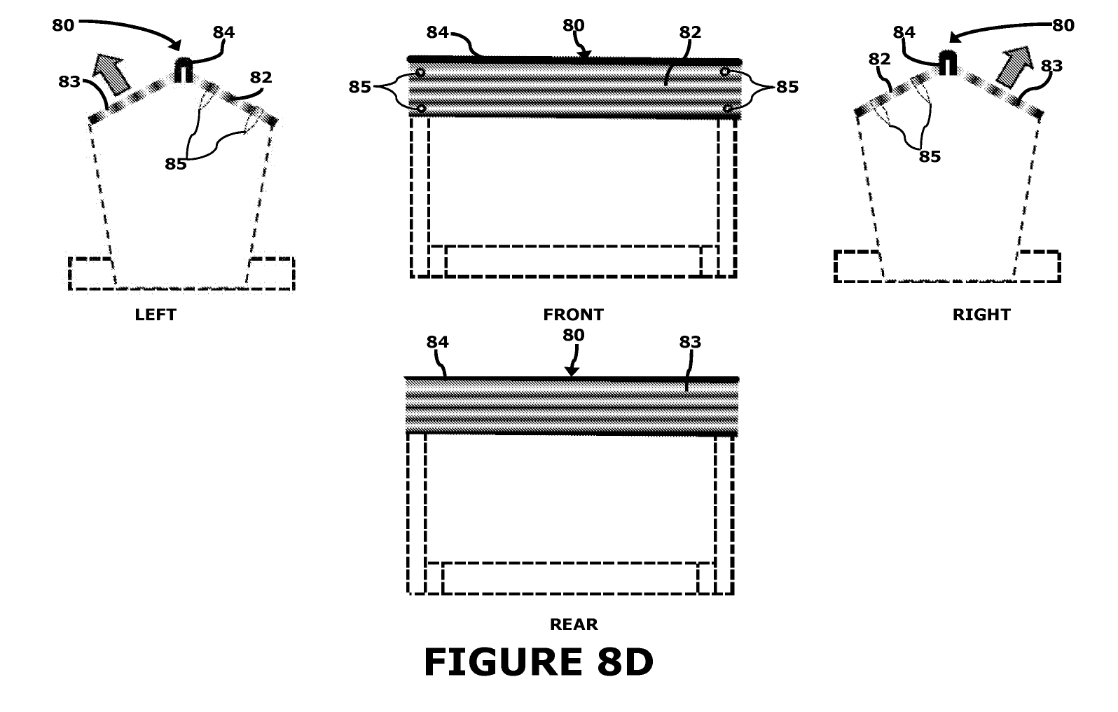

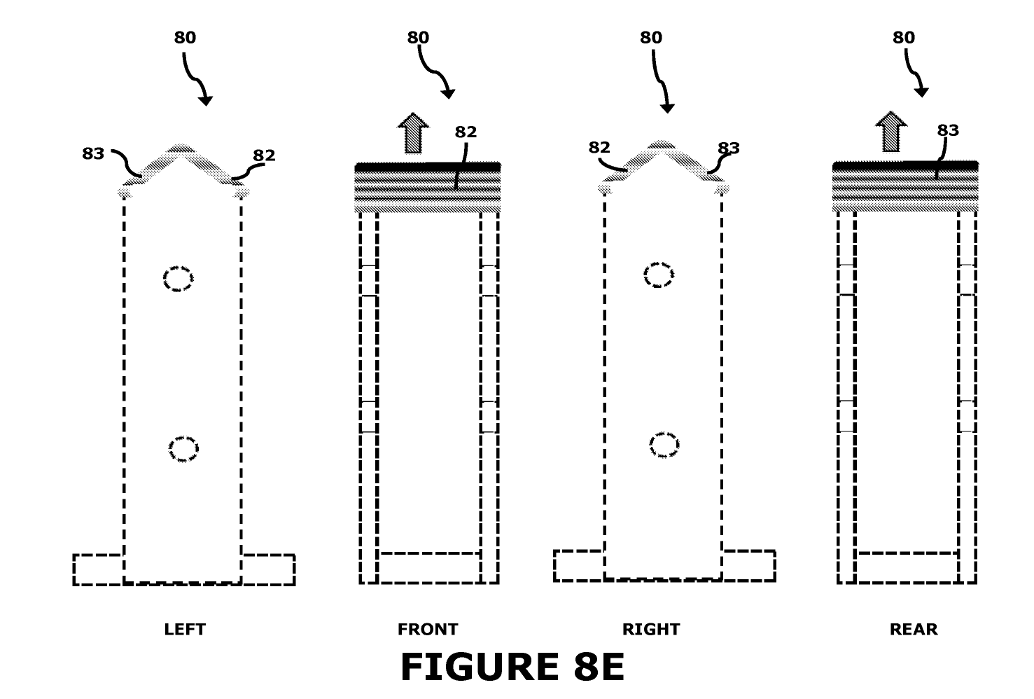

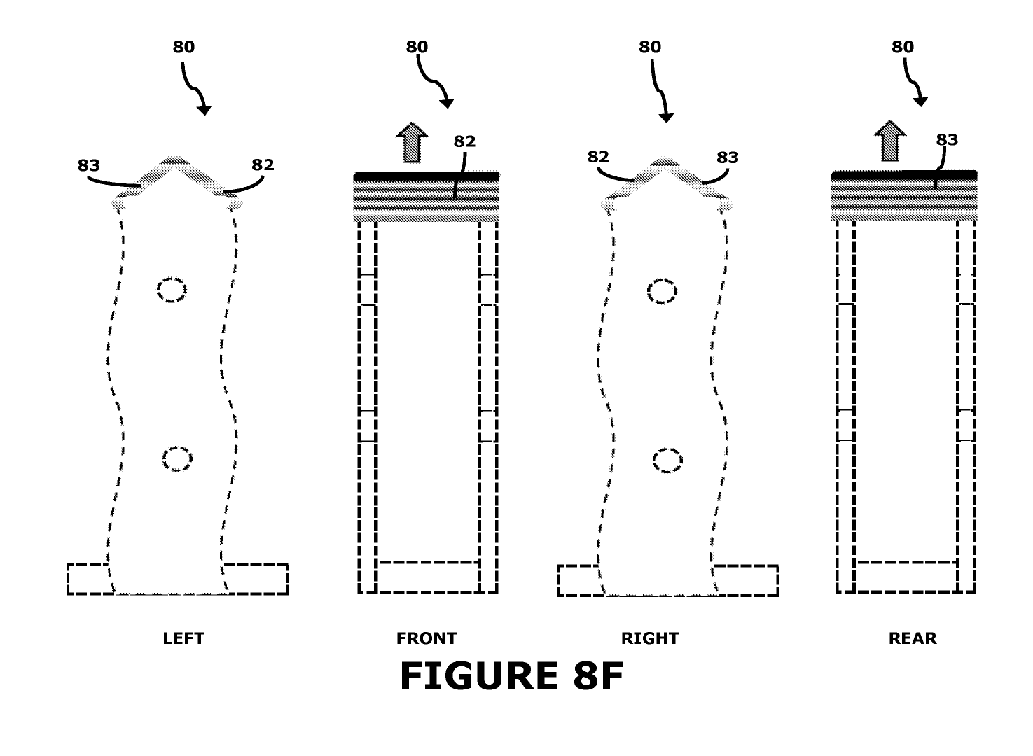

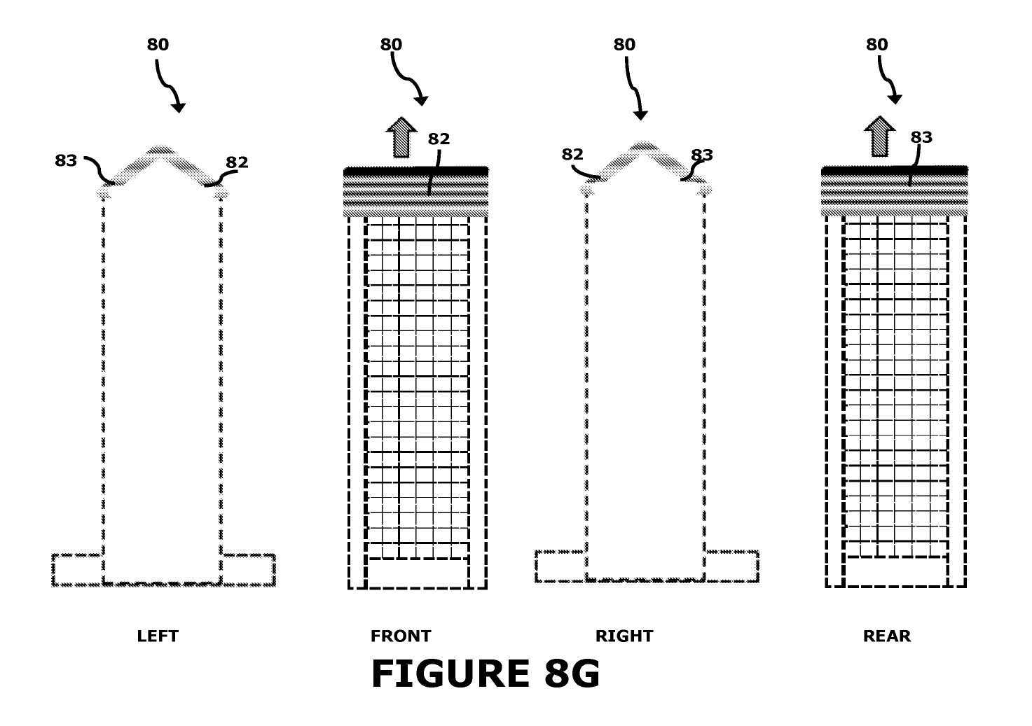

Referring to FIGS. 8A-8G, the roof 80 can include a front awning 82 and a rear awning 83 which cover a top opening of the housing 70. The roof 80 is preferably movable to allow access to the compartment 61 so that birdfeed can be poured into the compartment 61.

The awnings 82-83 can be attached together via a hinge 84 which allows one awning to be selectively lifted. (See e.g., FIGS. 8A-8D.) With such a hinged-roof arrangement, one awning can be attached to housing 70, and more particularly its lateral panels 74-75 with fasteners 85. In the roofs 80 shown in FIGS. 8A-8D, the front awning 82 is attached to the housing 70 and the rear awning 83 can be lifted upward.

Alternatively, the awnings 82-83 can be attached together and mounted so that both may be lifted. (See e.g., FIGS. 8E-8G.) In this case, the roof 80 could be slidable on a cable attached to the housing 70.

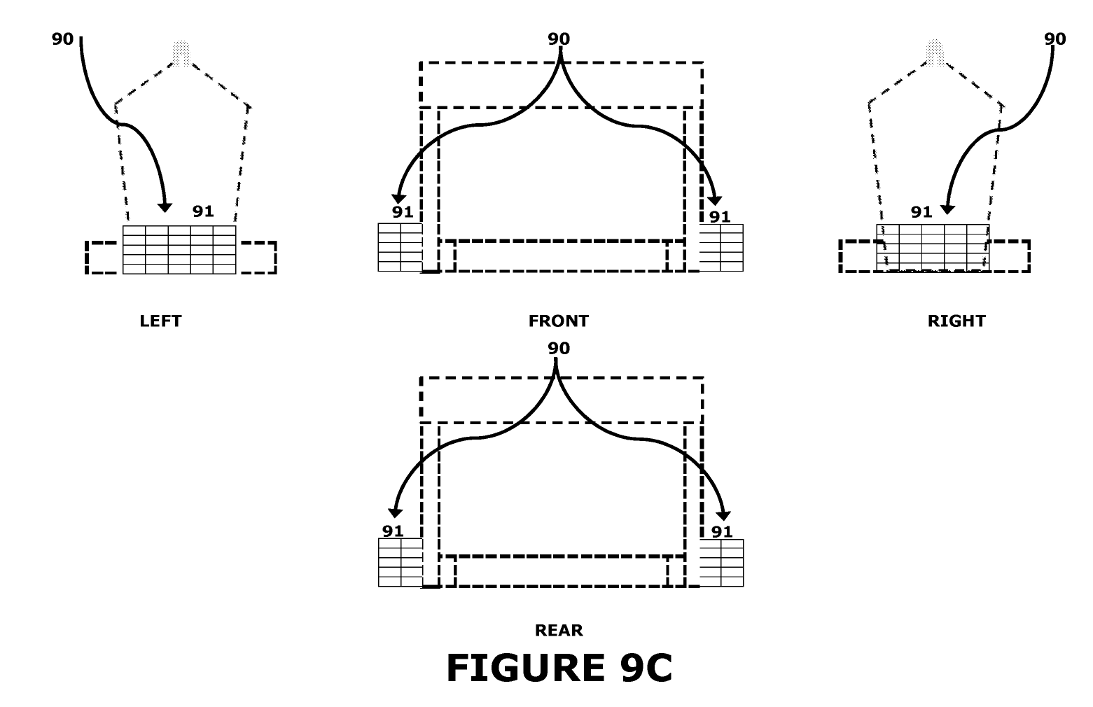

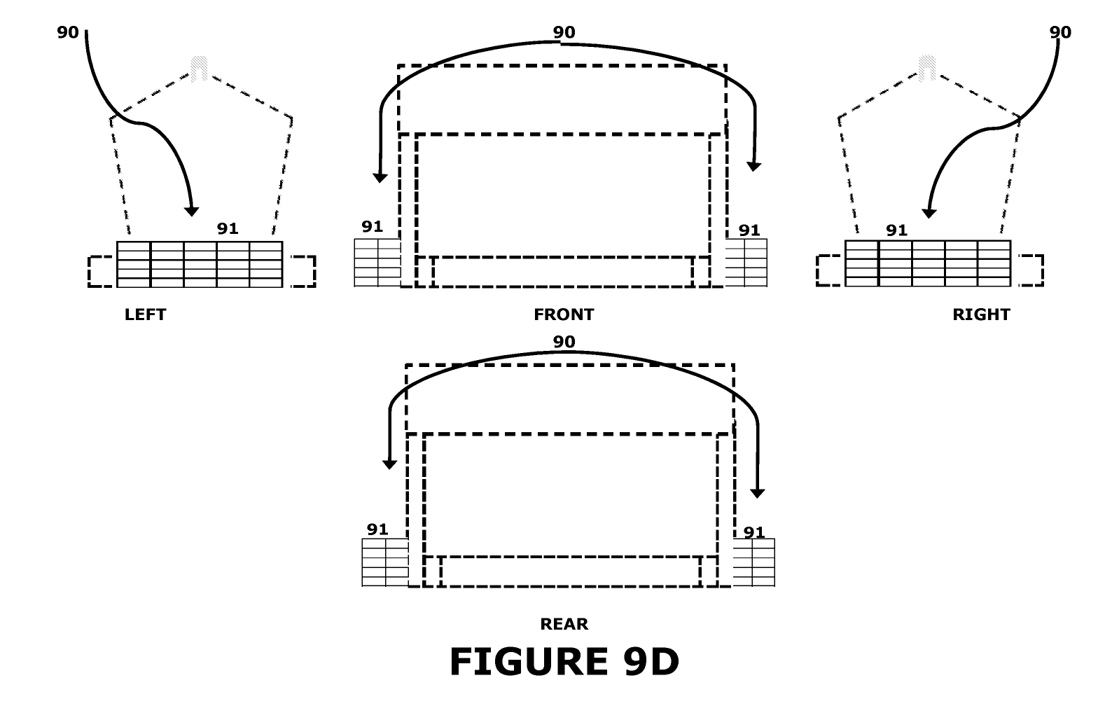

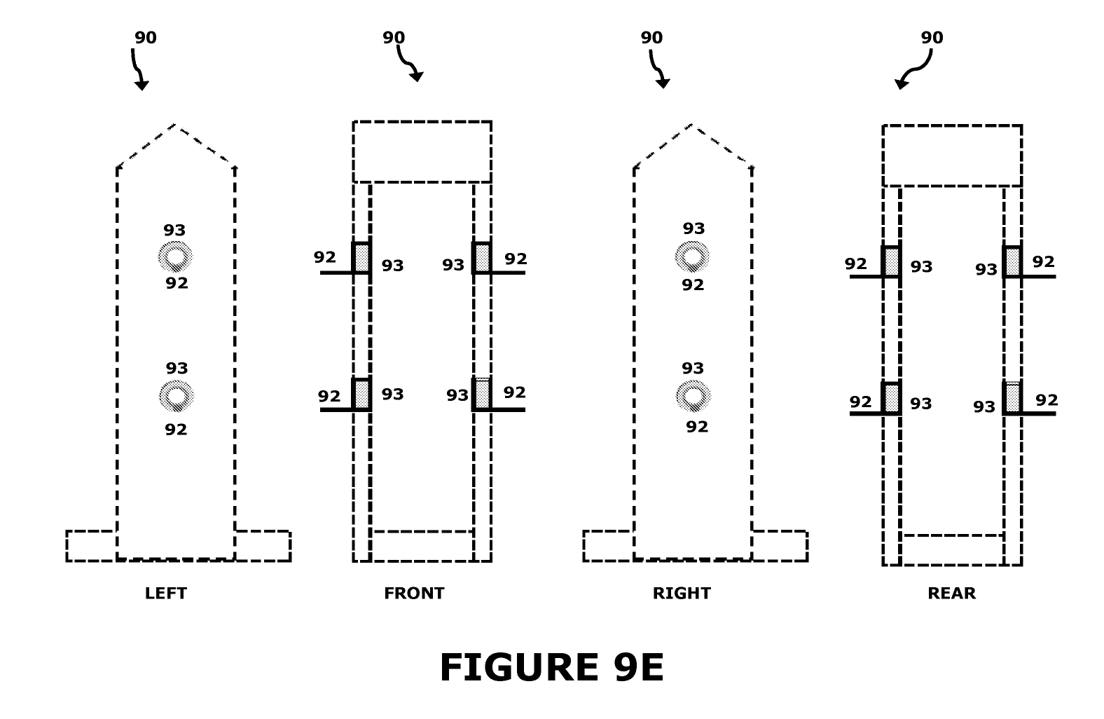

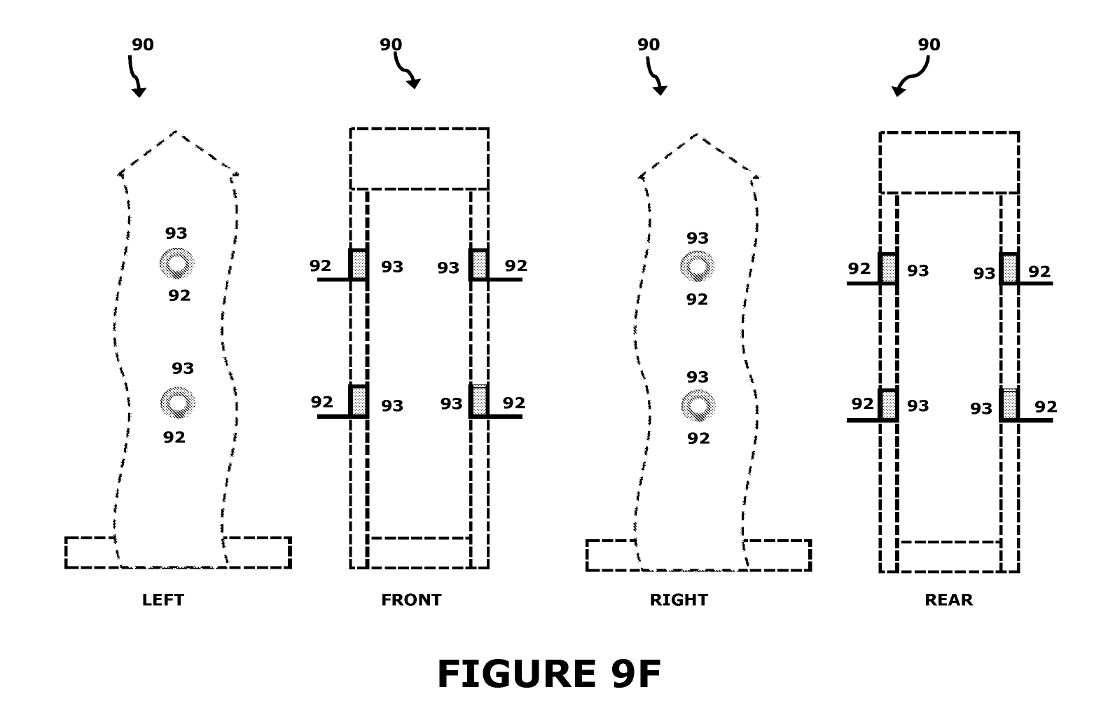

Referring to FIGS. 9C-9F, additional accessories 90 can be provided for the birdfeeders 10 as necessary or desired. The birdfeeders 10 shown in FIGS. 1C-1D, for example, are equipped with side baskets 91 for bulkier feed. The baskets 91 can be fastened (e.g., stapled) to the lateral frame members 34-35 and/or the lateral housing panels 75-75. The birdfeeders 10 shown in FIGS. 1E-1F have perches 92 and feeding ports 93 integrated into their housings 70.

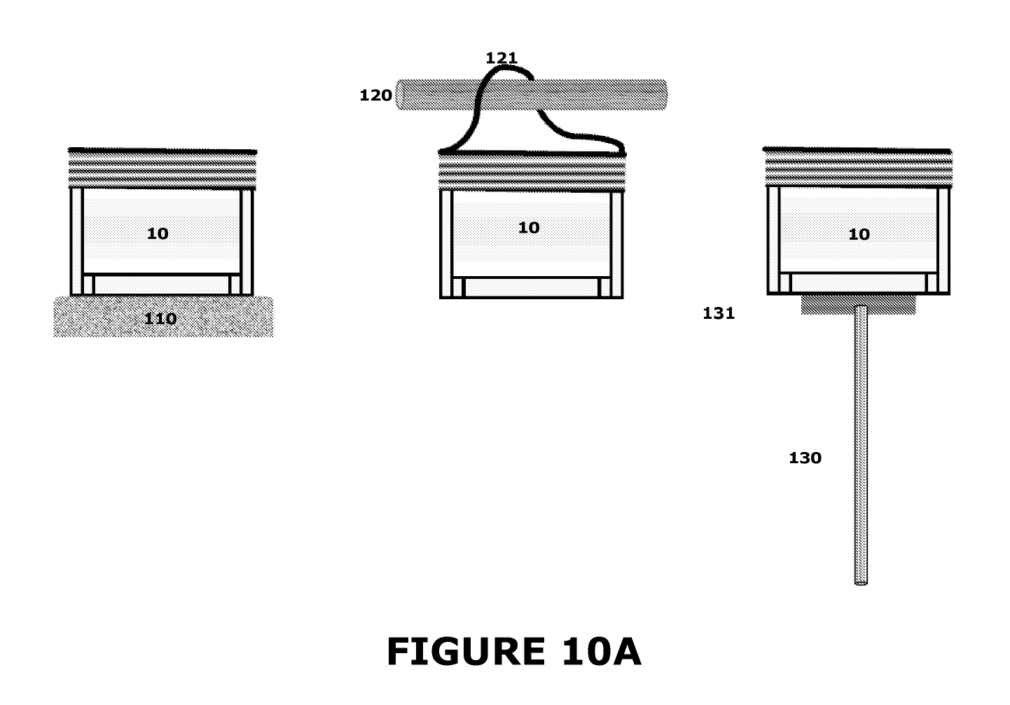

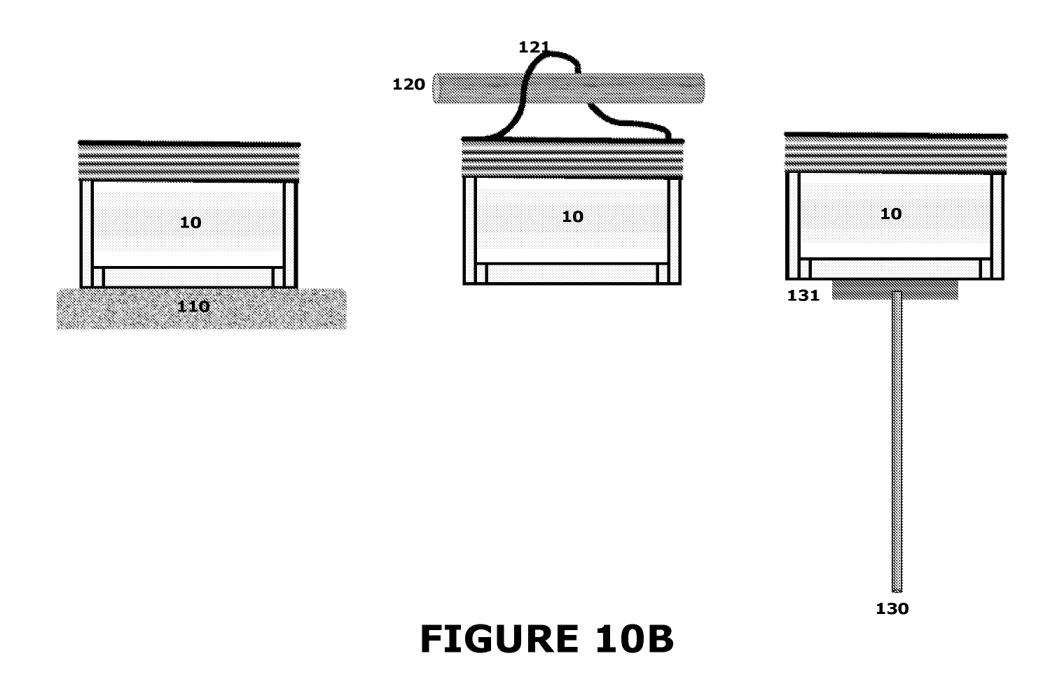

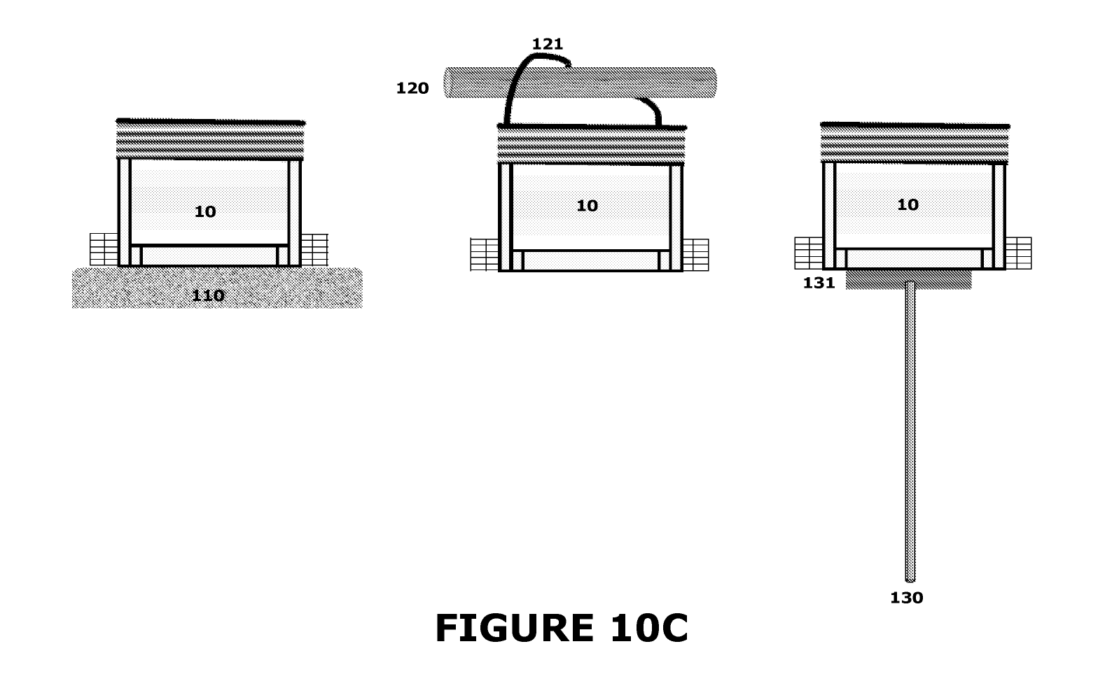

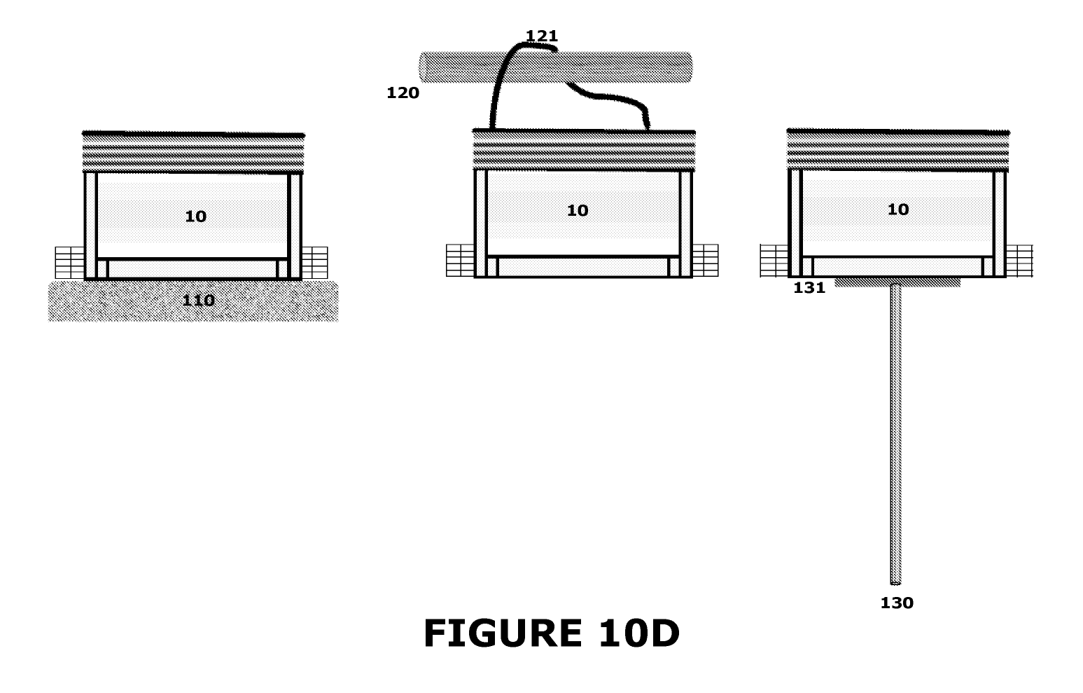

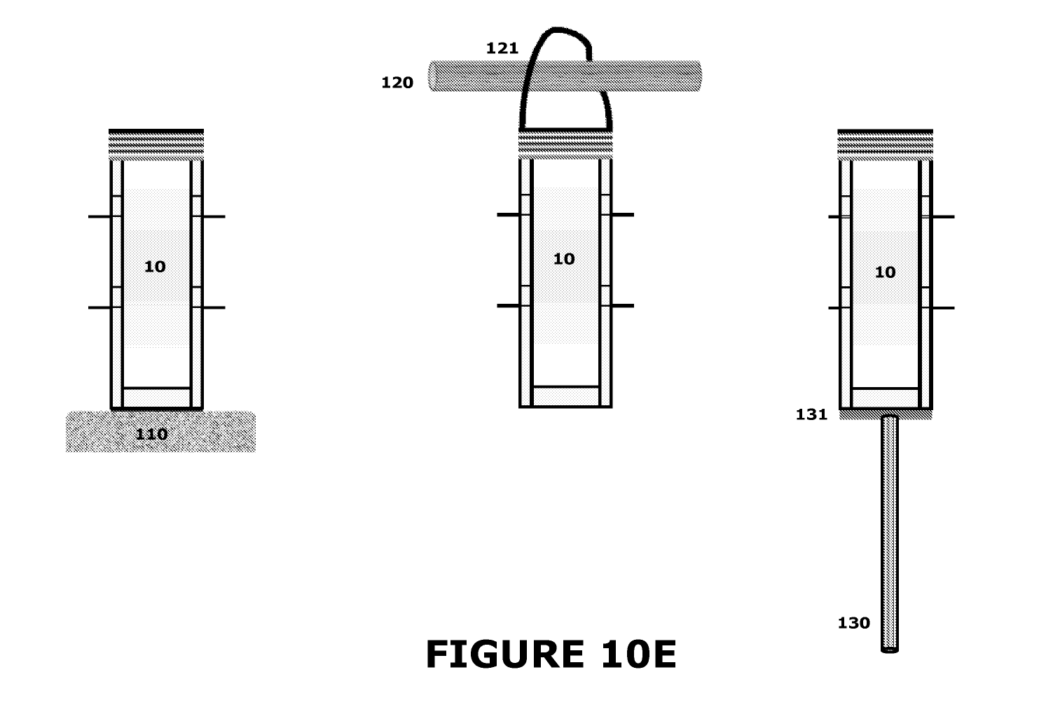

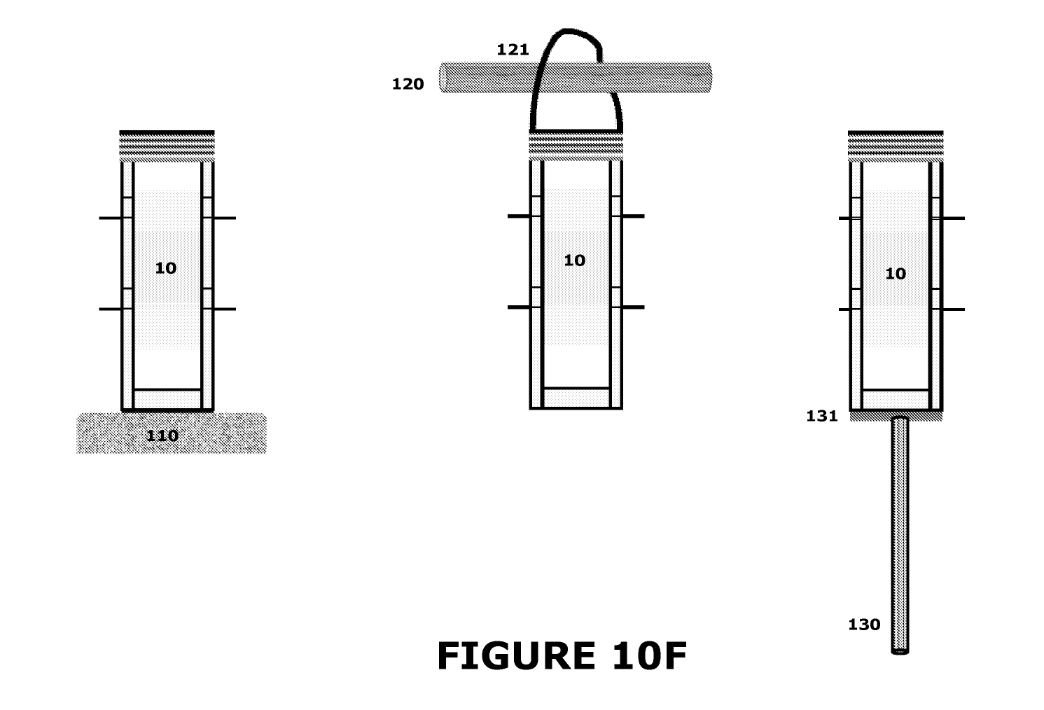

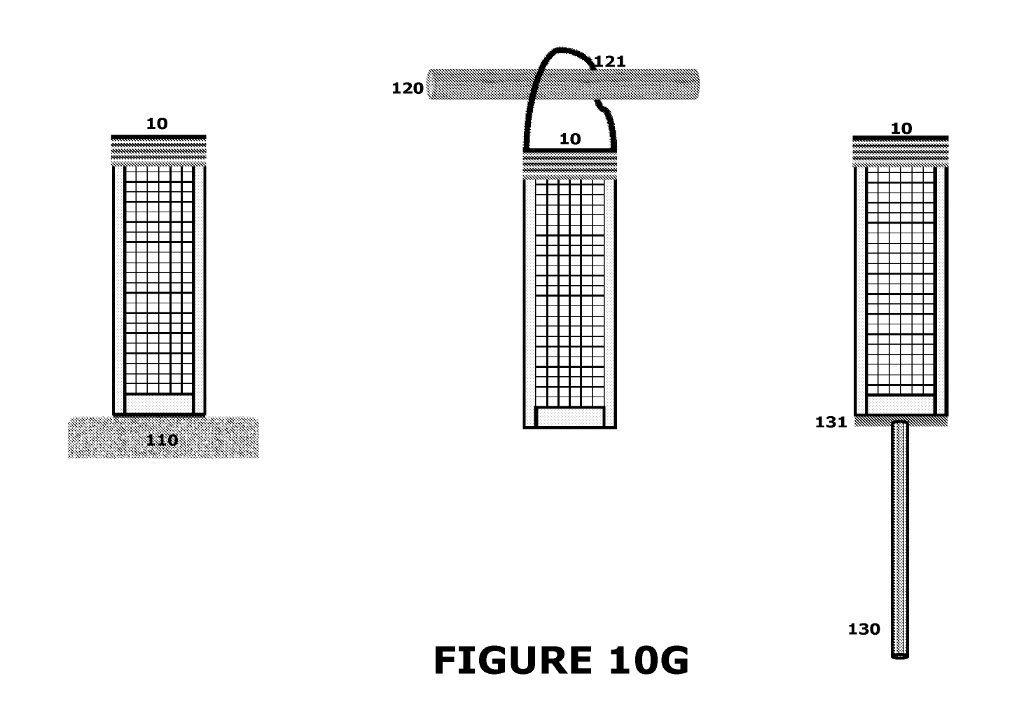

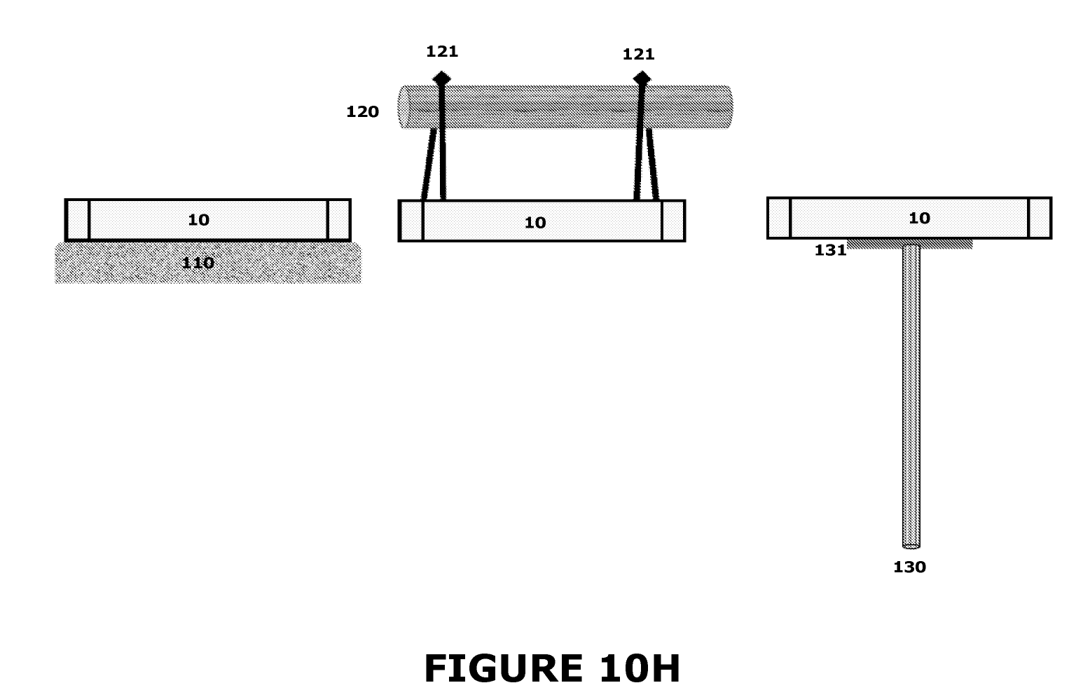

Referring to FIGS. 10A-10H, each of the birdfeeders 10 can be mounted in a variety of ways. Thanks to the vertical positioning of the railing 50 relative to the base's bottom boundary 27, the birdfeeders 10 have flush bottom surfaces (e.g., the bottom faces of the frame members 32-35). Accordingly, the birdfeeders 10 can seat flush on a horizontal platform 110 without any other mounting equipment. Alternatively, each birdfeeder 10 can be suspended from a limb 120 by hangers 121 attached to its base 20 and/or its hopper 60. Further, the birdfeeders 10 can each be elevated on a pole 130 via a pole-mounting podium 131 which is attached to its base 20.

One may now appreciate that the birdfeeder 10 is provided with a base 20 which can be suspended, pole-mounted, or seated on a flat surface. The base 20 accommodates a floor 40 which is easily removable and which can be inexpensively made from a single sheet 41. And the base's frame 20 and/or its railing 50 can be economically made from the standard wooden boards. Although the birdfeeders 10, the bases 20, the frames 30, the floors 40, the railings 50, the hoppers 60, the housings 70, the roofs 80, the accessories 90, and/or the mounting arrangements are shown and described as having certain forms and fabrications, such portrayals are not quintessential and represent only some of the possible of adaptations of the claimed characteristics. Other obvious, equivalent, and/or otherwise akin embodiments could instead be created using the same or analogous attributes.

Also, the positional parameters (e.g., front, rear, left right) used in this description are for point-of-reference purposes to facilitate ease in explanation. These directional terms are not intended to convey precise birdfeeder poses, but rather to define the relational bearings among the elements. Accordingly, such positional parameters can be considered confirmed if the elements of a birdfeeder in any theoretical orientation would correlate therewith.

1. A birdfeeder comprising a base providing an open-topped tray adapted to present birdfeed in a bird-accessible manner; the base comprising:
a frame including frame members defining the side boundaries of the base and the tray and defining the bottom boundary of the base, the frame members being formed from wooden boards having the same standard depths and widths;
a floor including a flooring sheet defining a bottom boundary of the tray which is positioned above the bottom boundary of the base, the flooring sheet having an array of holes sized and spaced to contain birdfeed with the tray while still allowing moisture to drain therefrom; and
a railing including rail members situated below the bottom boundary of the of the tray but not below the bottom boundary of the base, the rail members being attached to the frame;
wherein the flooring sheet is unsecured to the frame and the railing whereby it is selectively removable therefrom; and
wherein the flooring sheet is characterized by unturned edges.

2. A birdfeeder as set forth in claim 1, wherein the frame members comprise a front frame member, a rear frame member, a left frame member, and a right frame member arranged to define a rectangular area, and wherein the flooring sheet has a front edge situated immediately adjacent the front frame member, a rear edge situated immediately adjacent the rear frame member, a left edge situated immediately adjacent the left frame member, and a right edge situated immediately adjacent the right frame member.

3. A birdfeeder as set forth in claim 2, wherein the shape of the area is a slightly wide rectangle.

4. A birdfeeder as set forth in claim 2, wherein the shape of the area is a narrow rectangle.

5. A birdfeeder as set forth in claim 2, wherein the shape of the area is square.

6. A birdfeeder as set forth in claim 2, wherein the front and rear frame members have the same length, wherein the left and right frame members have the same length, this length being unequal to that of the front and rear frame members.

7. A birdfeeder as set forth in claim 2, wherein the front and rear end portions of the left and right frame members overlap lateral end portions of the front and rear frame members and are secured thereto.

8. A birdfeeder as set forth in claim 2, wherein the lateral end portions of the front and rear frame members overlap front and rear end portions of the left and right frame members and are secured thereto.

9. A birdfeeder as set forth in claim 1, wherein the flooring sheet comprises a front stage section a rear stage section, and diverter section positioned therebetween, and wherein the diverter section is designed to urge birdfeed towards the stage sections.

10. A birdfeeder as set forth in claim 1, wherein the flooring sheet is substantially planar and without a diverter section.

11. A birdfeeder as set forth in claim 1, wherein the rail members are disposed parallel to an opposing pair of frame members;
wherein the rails members are separated from each other by a nonzero rail-to-rail distance;
wherein each rail member is separated from its adjacent parallel frame member by a nonzero rail-to-frame distance; and
wherein the rail-to-rail distance is about equal to or greater than the rail-to-frame distances.

12. A birdfeeder as set forth in claim 11, wherein the rail members are formed from wooden boards having standard widths and depths.

13. A birdfeeder as set forth in claim 11, wherein the rail members are formed from metal rods.

14. A birdfeeder as set forth in claim 11, wherein the frame members comprise a front frame member, a rear frame member, a left frame member, and a right frame member arranged to define a rectangular area;
wherein the rail members comprise a left rail member and a right rail member;
wherein the left rail member and the right rail member are disposed parallel to the left frame member and the right frame member; and
wherein the left rail member and the right rail member are fastened to the front frame member and the rear frame member.

15. A birdfeeder as set forth in claim 11, wherein the frame members comprise a front frame member, a rear frame member, a left frame member, and a right frame member arranged to define a rectangular area;
wherein the rail members comprise a front rail member and a rear rail member;
wherein the front rail member and the rear rail member are disposed parallel to the front frame member and the rear frame member; and;
wherein the front rail member and the rear rail member are fastened to the left frame member and the right frame member.

16. A birdfeeder as set forth in claim 1, further comprising a hopper having a compartment for storing birdseed to replenish the tray;
wherein the hopper includes a housing having an open top and a roof covering the open top; and
wherein the housing includes panels surrounding the compartment, at least some of the panels being wooden walls.

17. A birdfeeder as set forth in claim 16 wherein at least some of the panels are transparent panes and/or screen panels.

18. A birdfeeder as set forth in claim 1, seated flush on a horizontal platform, wherein the bottom surfaces of the frame members rest against the horizontal platform.

19. A birdfeeder as set forth in claim 1, suspended from a limb by hangers attached thereto.

20. A birdfeeder as set forth in claim 1, elevated on a pole via a pole-mounting podium which is attached to its base.
